(19) United States
(12) Patent Application Publication
(10) Pub. No.: US 2005/0216264 A1
(43) Pub. Date: Sep. 29, 2005

(54) Speech dialogue systems with repair facility

(76) Inventors: David J Attwater, Ipswich (GB); Peter J. Durston, Ipswich (GB); Fergus R. Mcinnes, Edinburgh (GB)

Correspondence Address: NIXON & VANDERHYE, PC, 901 NORTH GLEBE ROAD, 11TH FLOOR, ARLINGTON, VA, 22203, US

(21) Appl. No.: 10/517,648

(22) PCT Filed: Jun. 20, 2003
(86) PCT No.: PCT/GB03/02672

§ 371 Date: Dec. 13, 2004

(30) Foreign Application Priority Data
Jun. 21, 2002 (EP) 02254354.0

(51) Int. Cl. G10L 15/00

(52) U.S. Cl. 704/239

(57) ABSTRACT

The system has a speech recogniser (2) for recognising speech from a user and a synthesiser (6) for replying to him and engages in a dialogue with the object of enabling the user to convey to the system a piece of information such as a telephone number. The system builds up the number in a buffer (10). Each time it receives a string of digits, it reads it back for confirmation. When a number (or part of one) is read back, it is divided into “chunks” according to certain criteria: the positions of these divisions can be recorded to be taken into account in later processing. Responses are compared with the current buffer contents to determine whether they it should be interpreted as a correction, partial correction or pure continuation of the existing contents. Positions in the buffer at which pure continuations are entered are marked, to allow a “final repair” process in which, if the final result fails to match some criterion of acceptability (e.g. length) the marked positions can be reexamined to determine whether interpretation instead as correction or partial correction would meet the criterion. Algorithms are described for comparing new input with digits already received, to decide how it is to be interpreted.

### CHAPTER I: INTRODUCTION

The present application is concerned with methods and apparatus for use on performing speech dialogues, particularly, though not exclusively for such dialogues performed over the telephone.

### PRIOR ART

In “How to Build a Speech Recognition Application”, B. Balentine, and D. P Morgan, 2002, a system is discussed which, having recognised a string of digits, reads them back to the user for confirmation. If a particular digit is reported by the recogniser as having poor reliability, the system interrupts its read-back at that point so that a confirmation can be received from the user before the system reads the digits which follow.

U.S. Pat. No. 6,078,887 (Gamm et al/Philips) describes a speech recognition system for numeric characters where a recogniser receives a string of spoken digits, and reads them back to the speaker for confirmation. If negative confirmation is received, the apparatus asks for a correction. If the correcting string has a length equal to or greater than the original input, it is used unconditionally to replace and (if longer) continue the original one. If on the other hand it is shorter, it is compared at different shifts with the original input to obtain a count of the number of matching digits. Using the shift that gives the largest number of matches, the new string is used to overwrite the old string.

Another interesting discussion of automatic numeric recognition is to be found in “Robust numeric recognition in spoken language dialogue” (Rahim, Riccardi, Saul, Wright, Buntschuth and Gorin), Speech Communication 34, Elsevier Science B.V. (2001), pp. 195-215.

### INVENTION

Various aspects of the invention are set out in the claims

Some embodiments of the invention will now be described, by way of example with reference to the accompanying drawings, in which:

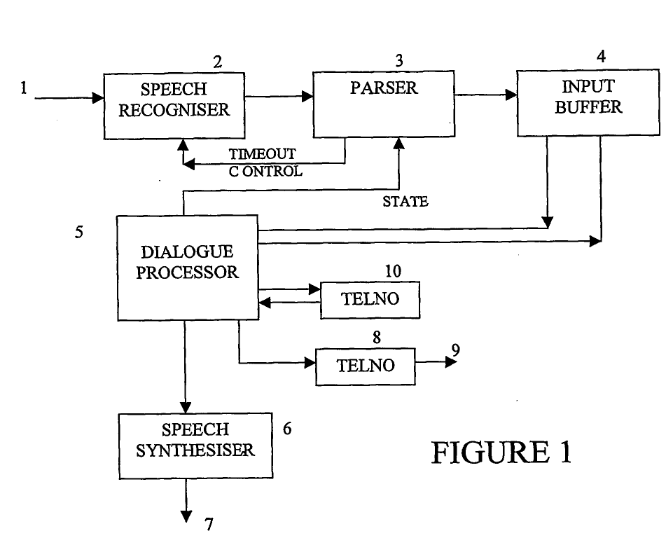

FIG. 1 is a block diagram of an interactive speech dialogue system;

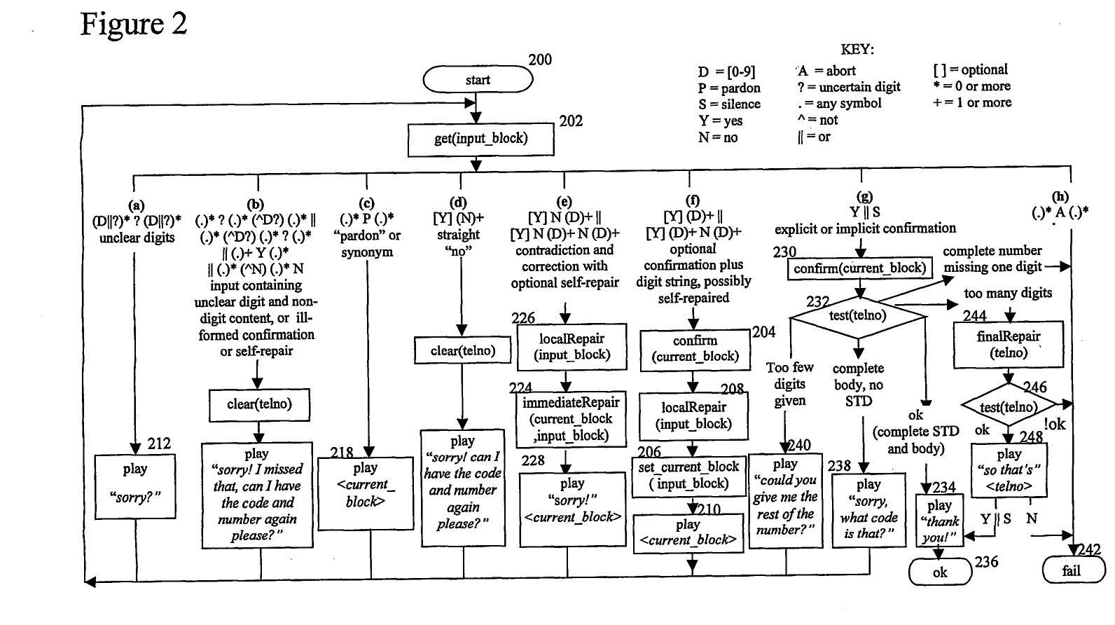

FIG. 2 is a flowchart showing the operation of a voice dialogue;

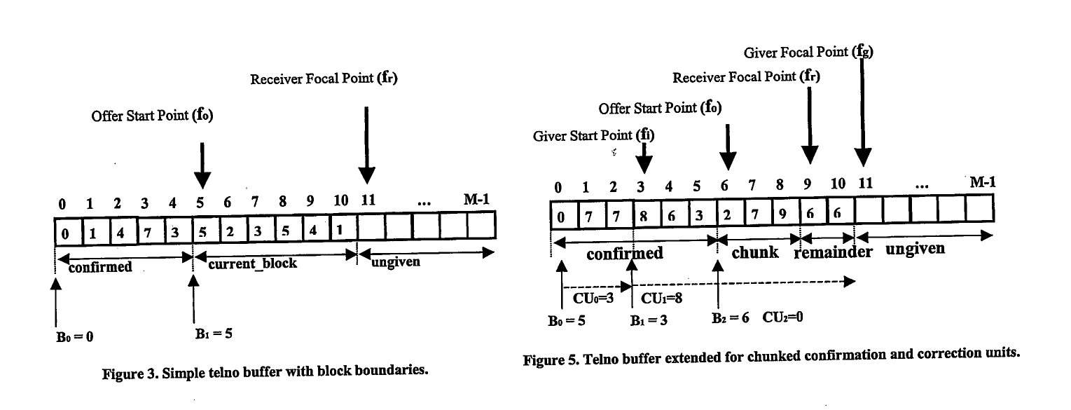

FIG. 3 is a diagram illustrating a simple telephone number buffer;

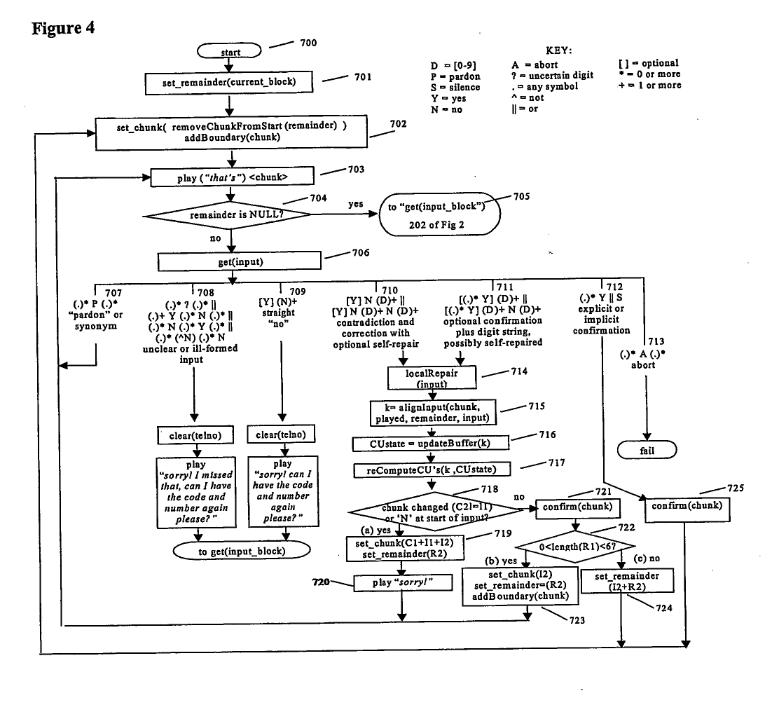

FIG. 4 is a flowchart illustrating a chunked confirmation sub-dialogue which may be used with the dialogue of FIG. 2;

FIG. 5 is a diagram illustrating an extended telephone number buffer;

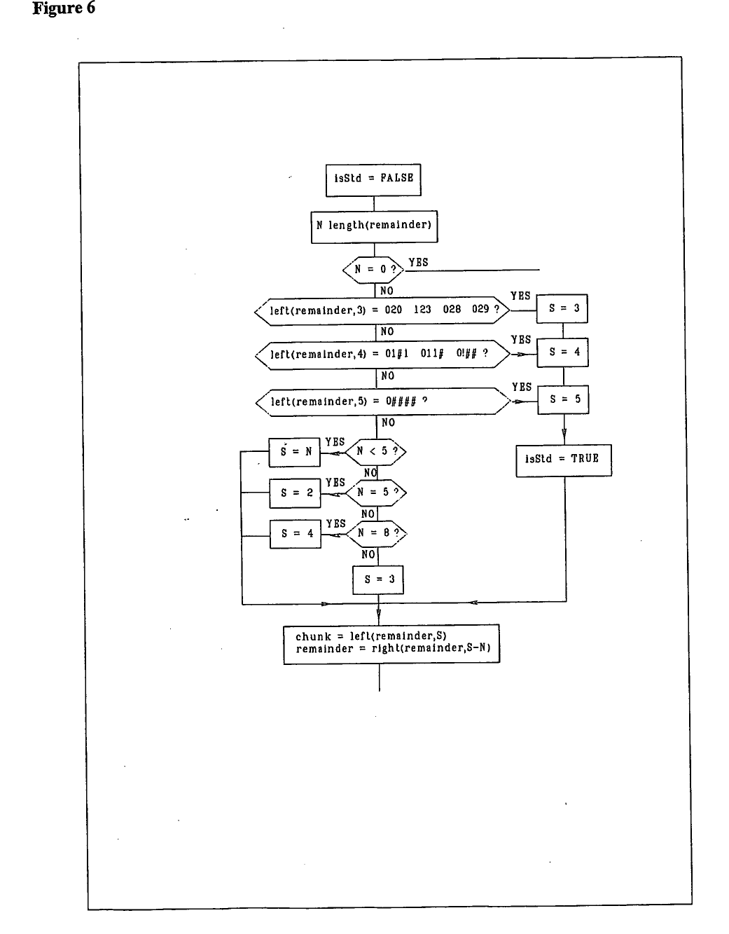

FIG. 6 is a flowchart showing one way of dividing a string into chunks;

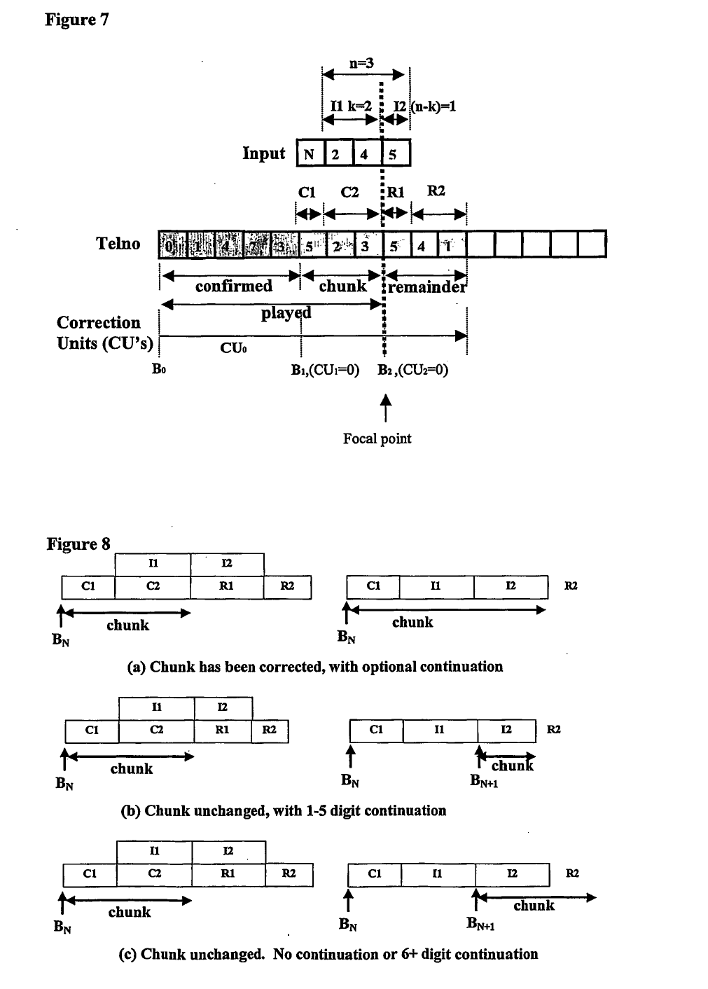

FIG. 7 is a diagram illustrating alignment of an input against the extended buffer;

FIG. 8 is a diagram illustrating block boundaries and chunks;

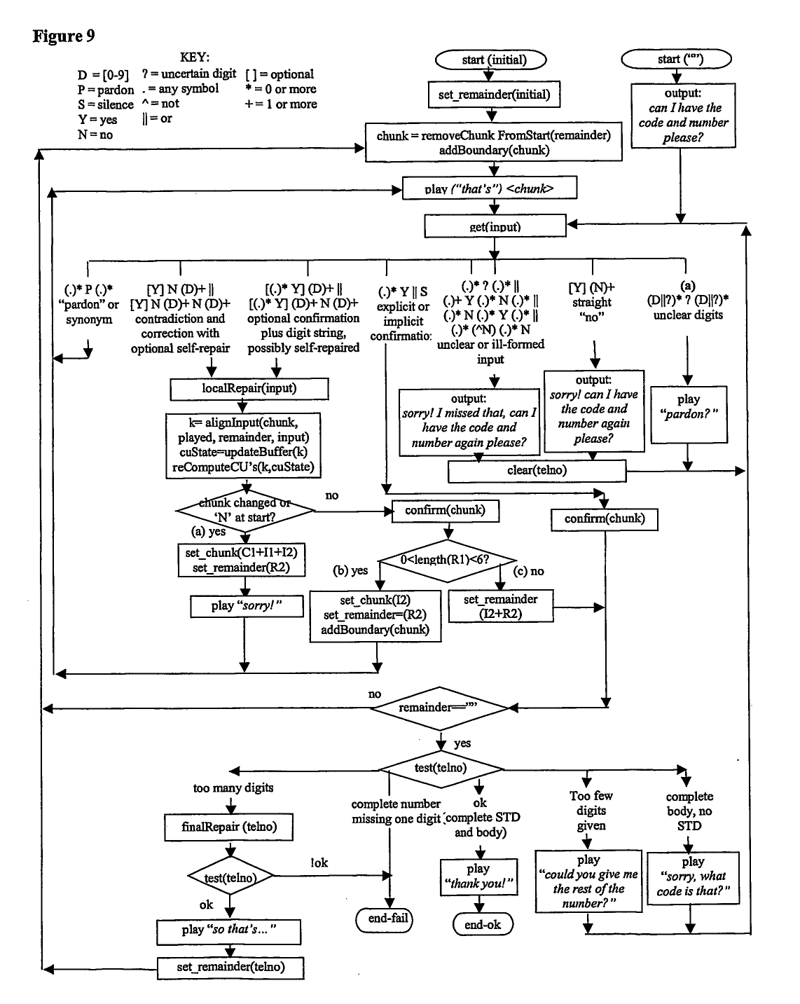

FIG. 9 is a flowchart showing a dialogue according to a further embodiment of the invention;

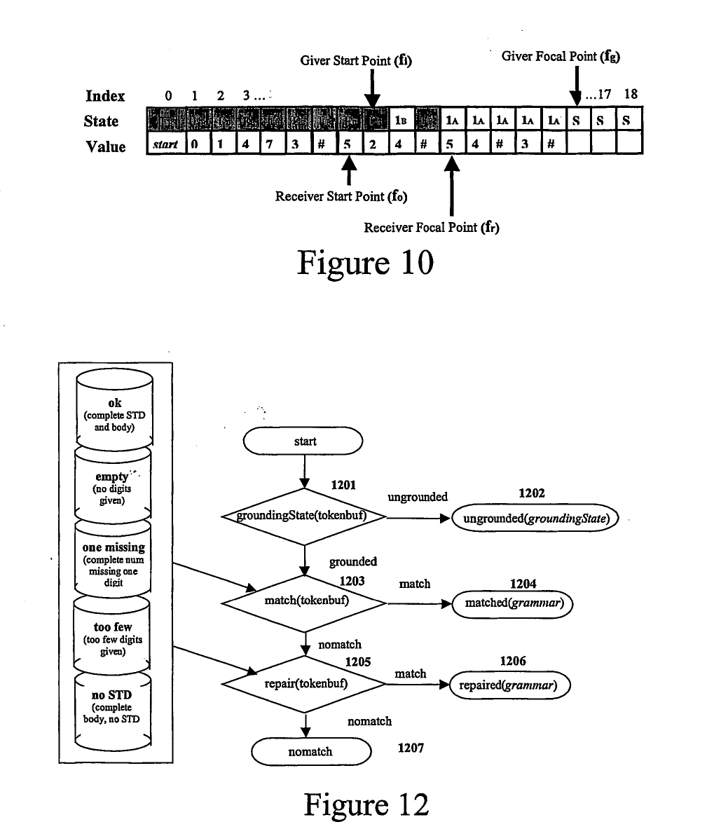

FIG. 10 is a diagram of a buffer structure used in a fourth embodiment of the invention;

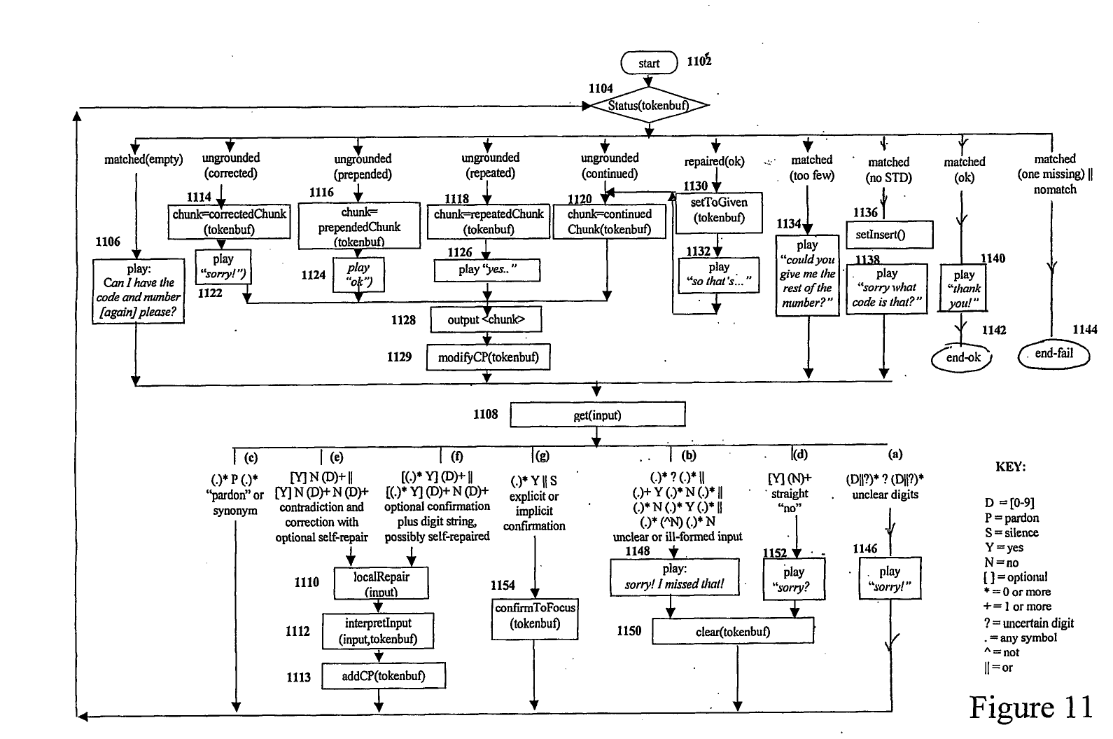

FIG. 11 is a flowchart showing the operation of a voice dialogue in accordance with this fourth embodiment;

FIG. 12 a flowchart showing the operation of part of FIG. 11;

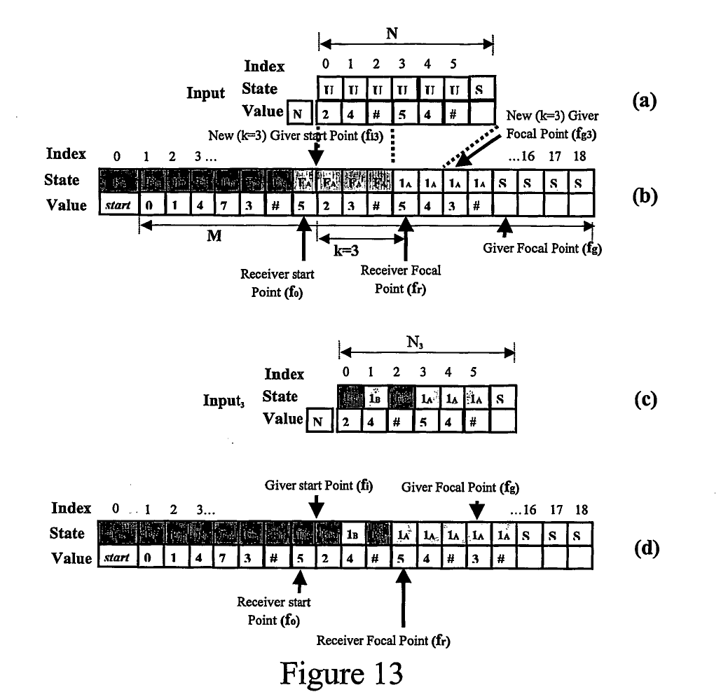

FIG. 13 a diagram illustrating alignment of an input against the buffer of FIG. 10;

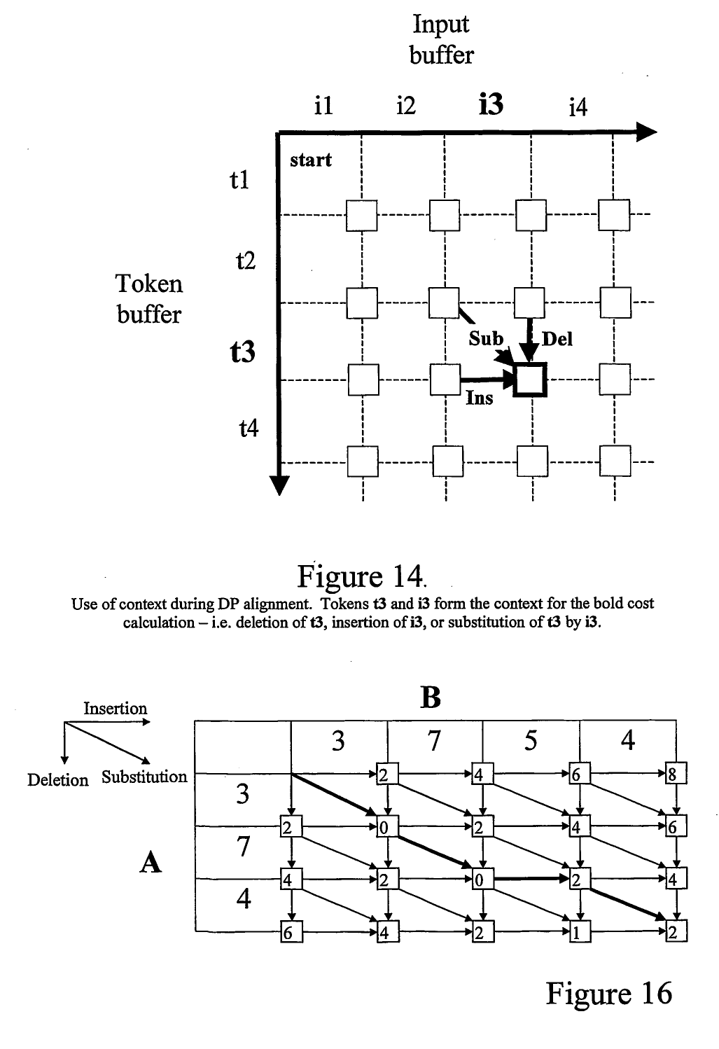

FIG. 14 a diagram showing the use of context in alignment of FIG. 13;

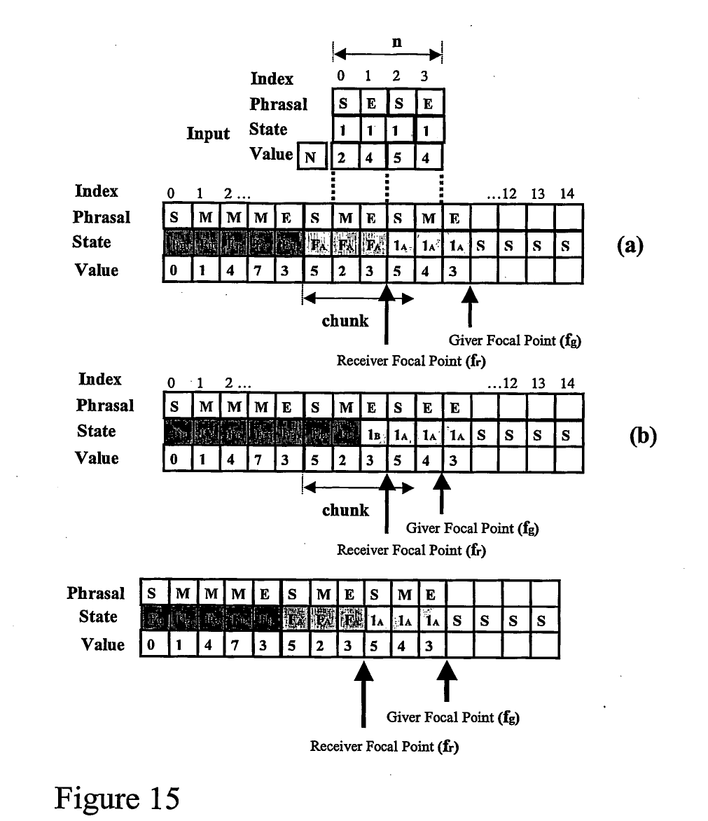

FIG. 15 shows an alternative method of recording phrasal boundaries; and

FIG. 16 illustrates the principles of dynamic programming

### CHAPTER II: INFRASTRUCTURE

The system now to be described offers a dialogue design for a telephone number transfer dialogue, suitable, for example, for use in a telephone call handling system. The intention of the design is to enable givers to transfer numbers in chunks rather than as a whole number and allow auto-correction of problems as they occur. When discussing the caller's role in the conversation the term ‘giver’ will be used. When discussing the automated dialogue system's role in the conversation the term ‘receiver’ will be used.

In FIG. 1, an audio input 1 (for example connected to a telephone line) is connected to a speech recogniser 2 which supplies a text representation of a recognised utterance to a parser 3. The recogniser operates with a variable timeout for recognition of the end of an utterance. The parser 3 receives the recognition results produced by the recogniser 2, and regularises them, as will be described later, for entry into an input block buffer 4. Also, on the basis of the recognition results so far, and an external input indicating a current “dialogue state”, the parser 3 controls the recogniser timeout period, that is, a duration of silence following which an utterance is considered complete. Once the complete utterance has been recognised, it is transferred to the buffer 4.

The actual dialogue is controlled by a dialogue processor 5, consisting of a conventional stored-program controlled processor, memory, and a program for controlling it, stored in the memory. The operation of this program will be described in detail below. In this example the function of the processor is to elicit from a giver a complete telephone number. It can interrogate the buffer 4 to obtain a coded representation of a recognised utterance, provide spoken feedback to the giver via a speech synthesiser 6 and audio output 7, and aims to deliver a complete telephone number to an output buffer 8 and output 9. It also signals dialogue states to the parser 3.

FIG. 1 also explicitly shows (for the purposes of illustration) a buffer 10 used for the manipulation of intermediate results: in practice this would simply be an assigned area of the processor's memory. In the following description, this buffer is referred to as the telno (telephone number) buffer or—reflecting the fact that the same processes can be applied to inputs other than numbers—the token buffer.

The description shows the use of grounding dialogue to input telephone numbers into an automated system. The systems described are also suitable for any transfer of token sequences in conversation between a caller and an automated service. Other examples include:
SMS dictation
EMail dictation
EMail addresses
UK postcodes
US ZIP codes
IP addresses
URLs
Telephone numbers
General alphanumerics
   account numbers,
   product codes,
   national insurance numbers,
   car registration plates, etc.

Recogniser 2: Spoken Input Recognition

The following words cover the majority of observed giver vocabulary items used by UK English speakers in spontaneous number transfer dialogues:
{oh zero nought 1 2 3 4 5 6 7 8 9 double triple ten eleven twelve thirteen fourteen fifteen sixteen seventeen eighteen nineteen twenty thirty forty fifty sixty seventy eighty ninety hundred no yes yeah yep that's_right sorry pardon}

Natural numbers in the range “eleven” to “ninety-nine” are extremely rare in UK English telephone number transfer dialogues and are included for illustration purposes only as they are more common in the US. They would probably be omitted in a practical UK solution. Also in the UK “hundred” is only used in the context of STD codes such as “oh 8 hundred”.

Recognition of the input utterance may be done using any language model or grammar designed to model the range of spoken utterances for a natural digit block. For example a bigram based on observed word-pair frequency in real human-human or human-computer chunked number transfer system would be suitable.

Parser 3: Spoken Input Interpretation

The output of the input digit block is a single sequence of symbols representing the meaning of the input from the giver. The dialogue processor 5 expects this sequence to contain any sequence of the following set of symbols:
{0 1 2 3 4 5 6 7 8 9 N Y S P ? A}

This sequence may be derived from the input set of recognised words by a simple parser An example of one suitable parser is shown in Table 1. It is based on an ordered set of cascaded regular expression substitutions, formally cascaded finite state transducers (cFST's), operating on the top-1 word list candidate of the speech recognition output.

One important thing to note is that in the current design the speech recogniser is delivering a top-1 sentence to the parser without any confidence measures. Therefore a simple pre-processing stage is required to represent low-confidence utterances. Any single word in the input utterance which has a word-confidence level below a pre-defined threshold is replaced by the symbol ‘?’ which is retained unaltered through the subsequent cFST translation. In addition, any utterances which are wholly rejected by the speech recogniser are replaced by a single ‘A’ for abort in the input to the cFST. Silent utterances are presented as empty strings (indicated here by the symbol “ε”) to the parser.

The cFST shown in Table 1 is broken into two stages. Stage 1 simply regularises natural numbers to a canonical form and removes filled pauses if they are present in the input string. Stage 2 interprets the synonymous forms of other qualifier words. These words are used by the giver for confirmation (Y), contradiction(N) and requests to hear the previous digit block again (P). Note, “sorry?” without subsequent digits will be treated as “pardon” (requesting a repetition of the echoed block) and becomes the symbol ‘P’, however “sorry” followed by digits will be treated as “no” (introducing a correction). This matches observed UK caller behaviour. Completely empty strings representing silence are mapped to the symbol ‘S’.

TABLE 1
Simple parser to derive the input for dialogue rules as shown
in Figure II. from the output of the speech recogniser. Cascaded
finite state transducers are used (cFST's)

| Input | | Output | Input Context |
|---|---|---|---|
| Symbols | | symbols | (pre_{——}suff) |
| Stage 1. Number Regularisation | | | |
| erm ∥ uh | → | ε | |
| zero ∥ oh ∥ nought | → | 0 | |
| ten | → | 1 0 | |
| eleven | | 1 1 | |
| twelve etc . . . | | 1 2 | |
| twenty | → | 2 | _{1, 2, 3, 4, |
| | | | 5, 6, 7, 8, 9} |
| twenty | → | 2 0 | |
| thirty | → | 3 | _{1, 2, 3, 4, |
| | | | 5, 6, 7, 8, 9} |
| thirty etc . . . | → | 3 0 | |
| double 0 | → | 0 0 | |
| double 1 etc . . . | → | 1 1 | |
| triple 0 | → | 0 0 0 | |
| triple 1 etc . . . | → | 1 1 1 | |
| hundred | → | 0 0 | |
| Stage 2 Qualifier Regularisation | | | |
| yes ∥ yeah ∥ yep ∥ that's_right | → | Y | |
| no ∥ sorry | → | N | _{0, 1, 2, 3, 4, |
| | | | 5, 6, 7, 8, 9} |
| pardon ∥ sorry | → | P | |
| no | → | N | |
| ε | → | S | sentenceStart_{—} |
| | | | sentenceEnd |

Grammar and Dialogue State Dependent Silence Timeouts

Human detection of the end of digit blocks employs a mix of prosodic interpretation and predictive expectations based on previous experience of typical syntax, chunking preferences for telephone number transfers, and expectations based on the current dialogue state. In human-human dialogue inter-chunk boundaries can be responded to before any silence is observed at the chunk ending. In this dialogue implementation, variable length silence timeouts based on grammar triggers are used to emulate the syntactic aspects of this effect. These are dependent on the current dialogue state and the lexical history of the input to the current point This could be augmented with prosodic recognition in the future.

To achieve this a parser needs to be integrated with the speech recognition acoustic search.

The Nuance Speech Recognition System “Developer's Manual” Version 6.2 (published by Nuance Corporation of California, USA) describes a method for retrieving partial recognition results at predetermined intervals, and acting on these to modify timeouts depending on the partial recognition result.

In the framework we describe here, the most recent partial result (the highest-scoring symbol history up to that point) is compared with a grammatical trigger pattern to determine the end-of-speech silence timeout to apply. Table 2 shows the ordered set of different timeout values in this design. Trigger patterns can be expressed as finite state grammars (e.g. regular expressions). Example trigger patterns are also given in the table. Given an ordered set of triggers the timeout to apply during recognition would be given by the first trigger to match the end portion of a partial recognition result its timeout value is adopted from that point onwards for the current recognition until another trigger occurs. A time interval between receiving partial results of 0.1s is sufficient to implement this feature.

An alternative method would be to define patterns which must match the whole of the utterance from the start. This approach may be less prone to substitution errors of small patterns during the partial evaluation of the result.

In the table, the pattern denoted (std) is equivalent to the following regular expression, using the notation of the perl programming language (for example in ‘perl in a nutshell’, ISBN 1-56592-286-7).
std=(\hat{ }020)∥(\hat{ }023)∥(\hat{ }024)∥(\hat{ }028)∥(\hat{ }029)∥(\hat{ }01[0-9]1)∥(\hat{ }011[0-9])∥(\hat{ }0[3-9][0-9][0-9])∥(\hat{ }0[1-9][0-9][0-9][0-9])

TABLE 2
Grammar dependent silence timeouts.

| Value | Pattern | Description |
|---|---|---|
| T_{S} | ε | Timeout for pure silence detection |
| T_{STD} | (std) | Reduced timeout at the end of an STD code |
| | | pattern (when STD is expected) |
| T_{Y} | Y | Extended timeout following a ‘yes’ |
| | | (except where dialogue already has |
| | | a full number) |
| T_{ND} | ND | Extended timeout during digit entry |
| | | following a ‘no’ |
| T_{N} | N | Extended timeout immediately following |
| | | a ‘no’ |
| T_{D} | ? | Default silence timeout (lengthened if STD |
| | | code is expected and not yet complete) |

TABLE 3
Dialogue states for modifying grammar dependent timeouts.

| State | Description |
|---|---|
| STD | An STD code is expected - This state occurs after |
| | each request for code and number, or a request for |
| | the code alone. |
| Chunk | A chunk is expected - An STD is not expected and |
| | not enough digits have yet been grounded to |
| | complete a telephone number |
| Inter-chunk | Chunk input during chunked confirmation - i.e. the |
| | grounding will be partial and digits have been |
| | given that are yet to be echoed. |
| Completion | A completion signal is expected - Enough digits |
| | have been grounded to complete a telephone number. |

TABLE 4
Illustrative values of timeouts

| State\ | | | | | | |
|---|---|---|---|---|---|---|
| Timeout | T_{S} | T_{STD} | T_{ND} | T_{N} | T_{Y} | T_{D} |
| STD | normal | 0/1.5 | 1.1/1.5 | ≧T_{ND} | 2.0 | 1.5 |
| | (4.0?) | | | | | |
| Chunk | normal | 0.7/1.5 | 1.1/1.5 | ≧T_{ND} | 2.0 | 0.7/1.5 |
| | (4.0?) | | | | | |
| Inter-chunk | 2.0 | 0.7 | 1.5 | ≧T_{ND} | 0.7 | 0.7 |
| Completion | reduced | 0.7/1.5 | 1.1/1.5 | ≧T_{ND} | 0.7/1.5 | 0.7/1.5 |
| | (3.0?) | | | | | |

Table 3 shows the different states of the dialogue used by the algorithm to select the particular numerical values (in seconds) of the grammar dependent timeouts—shown in Table 4. Where two values are given for the same timeout parameter in the same state, the first is designed for a chunked style of number input, and the second for an unchunked style. Exact values are not given for T_{S} (except in the inter-chunk state) or for T_{N}; but possible values for T_{S} are suggested. The exact timeout values might well be different in an implementation with an automated recogniser, but the pattern of relatively long and short timeouts should be similar.

T_{D} Once speech is detected, the acoustic search begins with a single default value T_{D} which could be though of as having a grammatical trigger matching the start of an utterance. The value of T_{D} is itself modified depending on the state of the dialogue. For example it is lengthened when an STD code is expected, to reduce the chance of a timeout during slow STD presentation. This value is also reduced in the inter-chunk state to keep the dialogue moving quickly.

T_{STD} This triggers for any valid STD code. When the dialogue is in the STD state e.g. following the initial “what code and number?” prompt, rapid detection of the end of this chunk is essential if a “chunked” style of interaction is preferred by the dialogue designer. Thus at these points T_{STD} may be set to zero—the recogniser returning a match as soon as it is sure that it has confidently recognised the final symbol of an STD sequence even if no silence has yet been detected following this. T_{STD} can be set to the default value T_{D} or even made larger than this to implement an “unchunked” dialogue style. In dialogue states where an STD code is not expected, T_{STD} has the same value as T_{D}.

T_{Y} The timeout is lengthened after a “yes” when the dialogue is in a state where a complete number or body has not yet been received (STD or chunk state). (This reduces the risk of giving a “rest of the number” prompt after “yes” when the giver was about to give the rest of the number anyway.) This value is also reduced in the inter-chunk state to keep the dialogue moving quickly.

T_{N} The timeout is lengthened immediately after a “no”, so that the beginning of a “no <digits>” correction sequence is not misinterpreted as a simple “no”. The timeout here may be longer than the timeout T_{ND} during the following digit sequence, since a longer pause is liable to occur immediately after the “no” than at a later point in the utterance.

T_{ND} The timeout is lengthened during a digit sequence preceded by “no” and also another digit. (This allows for the tendency of some givers to speak more slowly during a correction, and reduces the risk of timeout within an intended correction sequence leading to a wrong repair of the number.)

T_{S} Pre-speech silence detection timeout value is longer than default time-out (T_{D}). This is used to detect silence as a completion signal at the end of number transfer. Most current recognisers already implement this feature.

Those skilled in the art will be aware that in human-human conversations the prosody of an utterance—as well as grammatical patterns—plays an important role in the timing of turn-taking between actors in a conversation. It is anticipated that speech recognition algorithms in the future will also routinely mimic this ability. For example the extremely rapid detection of the end of an STD code observed in human-human number facilitated by grammatical knowledge of STD patterns, and also detected from the prosodic pattern of the chunking. “Is the speaker done yet? Faster and more accurate end-of-utterance detection using prosody” Ferrer, Shirbirg, Stolcke—ISCA Workshop on Prosody and Speech Recognition describes one method of doing this. Addition of this feature to the invention will increase its power to emulate the chunked transfer strategies seen in human-human conversation.

Cut-Through

Spoken input during the echoing of a block is ignored. This is because it has been observed that givers tend to defer to the follower when overlap occurs and ignoring attempts at interruption helps to enforce the intended chunked echo protocol,—reducing the risk of confusing the giver. Some of the embodiments of the invention described facilitate chunked confirmation. This involves speaking a number back to a giver by splitting it into chunks. After each chunk is spoken, there is a pause for spoken input between the chunks. Readback is continued if no response is received (i.e. silence). This pattern could be viewed as reading out a single number sequence containing internal phrasal boundaries. If it is viewed in this way then interruption should be viewed as permitted in the regions around the phrasal boundaries. (i.e. in the phrasal pause between blocks). Slight overlap of the interruption and the number output could be permitted at the boundaries.

### CHAPTER III: DIALOGUE, FIRST VERSION

Process Input Block

Dialogue Design

The main dialogue process performed by the processor 5 is shown in FIG. 2.

The number transfer dialogue is entered at the top of the flowchart (step 200) with the question “what code and number please?”. The preceding dialogue is not important for this invention. The purpose of this dialogue fragment is to correctly fill the telno buffer 10 which is initially empty. The basic strategy is to echo each block of digits received from the giver, until the giver gives a completion signal (such as “yes” or “that's right” or “thank you”) or remains silent for a pre-defined period following the reading out of an output block. Then if the telno buffer constitutes a complete telephone number, with no extra digits, the number transfer is taken to have succeeded and a terminating thankyou is given. The dialogue may then continue—for example to complete a line test or give a reverse charge call.

Telno Buffer Structure—First Version.

FIG. 3 shows the structure of the simple telno buffer (10). It has a series of locations, one for each digit (typically expressed as ASCII codes or similar). It needs to be long enough to accommodate one whole telephone number plus additional space to accommodate repetitions or errors that may arise en route. In this example the buffer has M locations (referred to as locations 0 to M-1).

The buffer is split into three regions. These regions record what state individual locations are in. These regions are ‘confirmed’, ‘current_block’, and ‘ungiven’. These regions are contiguous, and represented by two pointers:

The ‘offer start point’ fₒ points to the start of the last digits to be output.

The ‘receiver focal point’ fᵣ points to the location immediately AFTER the last digits to be output.

By definition:
confirmed=(0, fₒ−1)
current_block=(fₒ, fᵣ−1)

In the text that follows these relationships are considered to always hold true. Re-definition of fₒ for example, by definition means that the end point of confirmed has been re-defined also. Conversely, re-assignment of ‘confirmed’, for example, would alter the pointer fₒ accordingly as well.

The different regions in the buffer can be thought of as a way of assigning a particular state to each token in the buffer. The purpose of the dialogue can be seen as gathering values for these tokens and also progressing their dialogue grounding states from ‘ungiven’ through ‘offered’ (represented as the ‘current_block’) and to ‘confirmed’. The use of contiguous regions to represent this state is adequate for this simple first version of the dialogue. These states have the following definitions:

| | |
|---|---|
| ungiven | no token value has been received from the giver yet |
| | for this token. |
| offered | value has been received and offered by the receiver |
| | for confirmation |
| confirmed | the token has been confirmed by the giver. |

These states will be further developed in later versions of the dialogue.

In the example shown, fₒ=5 and fᵣ=11, Hence, confirmed=(0,4), and current_block=(5,10). The ungiven region is simply the remainder of the buffer which has no values set, and it will be omitted from diagrams where it adds no clarity. At the start of the enquiry, fₒ and fᵣ=0 are set to zero, i.e. confirmed and current_block are set to (0,−1). By convention, if the end index of a region is before the start index, the region is considered to be empty or null (“”). As the enquiry progresses these regions will change under the control of the dialogue processor (5). For clarity, these regions will be shown in figures as arrows spanning a region within the buffer, and their index values will be omitted.

The buffer also contains an ordered list of ‘block boundaries’. A block boundary is simply a historical record of the point in the buffer at the start of digit sequences which have been played back to the giver. In the first version of the dialogue, these block boundaries are simply placed at the start of each current_block each time current_block is re-assigned.

Block boundaries are stored as an array of L elements indexed from zero (i.e. B₀, B₁ . . . B_{L-1}), where L is an arbitrary limit greater than the number of blocks which will be exchanged in a dialogue (e.g. 20 for telephone numbers, as blocks can be as small as one digit and there could be additional correction digits). The value of each entry in the array records the index in the telno buffer where a block has started. In the example, the region marked confirmed will have previously been output as a ‘current_block’, which started at telno index 0. Therefore block boundary zero points to location zero (i.e. B₀=0). The current_block shown in the figure starts at index 5, so B₁=5. This is the last block boundary as it represents the start point of the current_block at this point in time. In the figures, the block boundaries will be shown as arrows pointing to the boundary to the left of the telno entry they are indicating.

The emerging telno buffer is therefore made up of ‘blocks’—i.e. the regions between block boundaries. At any given moment, the final block may be taken to be the region from the final block boundary to the start of the ‘ungiven’ region (i.e. fᵣ).

Block boundaries are recorded for use during the finalRepair( ).

### DEFINITIONS

A few important definitions are required to fully understand the flowchart.

| | |
|---|---|
| STD | This is any digit sequence which could be a national |
| | UK code such as 01473 or 0898. These patterns can be |
| | easily represented using a simple grammar. |
| Body | This is any digit sequence which could be a full |
| | telephone number excluding the STD code. These |
| | patterns can also be easily represented using a |
| | simple grammar. |
| block | The point in the digit sequence when a sequence of |
| boundary | digits began an output of a digit sequence. |
| Block | This is a sequence of digits which are being played |
| | out, or input, in a dialogue turn. A block may be |
| | any length from a whole phone number to a single |
| | digit. |
| input_block | This is the sequence of digits and symbols which |
| | represents the last giver turn as captured by the |
| | input buffer 4. |
| Telno | This is the buffer 10 containing the current |
| | telephone number hypothesis. It is made up from |
| | concatenated input_blocks and retains the block |
| | structure. |
| Current_block | This is the sequence of digits within the telno |
| | buffer that has been queued for output. |

get(Input) Referring to FIG. 2, at Step 202 this function retrieves a single regularised user utterance or ‘input_block’ from the input buffer 4.

Input Conditions

As can be seen in FIG. 2, once the input block has been captured and regularised, the output of this process is interpreted by the dialogue. The following cases are detected:

(f) Plain digits with optional preceding “yes”—possibly self-repaired digits. If the current_block is not empty then (204) add it to confirmed—i.e. set fₒ=fᵣ). The input buffer is (206) entered in the telno buffer as the new current_block. If there are digits in the buffer already, the new digits are added to the tail of the telno buffer; fᵣ is advanced to the next empty position. (Note: if desired the process could be modified so that input digits given in response to a prompt for the STD code are inserted at the head of the buffer.) If the input_block contains a self-repair (e.g. “yes 0 4 no 0 1 4 1 ”), it will first be repaired using the localRepair algorithm 208 described below prior to being added to the telno buffer. This new current_block is then echoed to the giver at Step 210, and a block boundary added at its start.

(a) Unclear digits. In case of an input_block entry that is unclear (e.g. “3 ? 4” with the middle digit being difficult to hear), the input_block is not added to telno, and a “sorry?” prompt is played (215) to prompt for a repetition of this block. (This mimics the use of “sorry” found in the operator dialogues.)

(b) Garbled input or ambiguous confirmation. In case of an input_block that is ill-formed or ambiguous, including any block with one or more unclear digits plus non-digit elements (e.g. “3 4 5 yes 3” or”no? ? 5”), the telno buffer is cleared (214)and the giver is prompted (216) for the code and number again. This is a catch-all state intended to match all conditions that other states fail to match. This condition could also be simply treated as an Abort condition (h) if desired.

(c) Pardon. In this case the current_block is simply repeated (218).

(d) Contradiction. A flat contradiction such as “no” in the input_block will cause the telno buffer to be cleared at 220, and the giver will be prompted at 222 for the code and number again.

(e) Contradiction and digit correction—possibly self-repaired digits. A correction starting with a contradiction word in the input_block such as “no 3 4 5” will be taken as a correction of the current_block. This is done at 224 using the immediateRepair algorithm as described below. If the input_block itself contains a self-repair (e.g. “no 0 4 no 0 1 4 1”), it will first be repaired using the localRepair algorithm 226 described below prior to conducting the immediate repair after this. Following the immediate repair the dialogue then (228) says “sorry” and echoes the corrected current_block.

(g) Completion signal (silence or “yes”). Once a completion signal is detected confirmed is extended 230 to include the current_block, and the current_block becomes null. Then the telno buffer is tested 232 using pre-defined grammar patterns to see whether it is complete or not-test(telno). The following cases may occur
ok—Complete STD and body. The dialogue says “thank you” at 234 and returns telno as the gathered telephone number in the ok state 236.
Complete body, no STD code. This can be detected by the fact that the first block does not start with “0”. When a complete number body without a code has been received, and the giver gives a completion signal or stays silent after the echo, the system requests (238) the code explicitly. This path, if provided, requires the modification mentioned above under (f).
Too few digits given. If the giver remains silent or gives a completion signal when the blocks of digits recognised and echoed so far do not make up a complete number or body, a prompt for the rest of the number is issued at 240.

An exception is made in the case where the number is exactly one digit too short, i.e. in the UK it has a valid geographic code (implying that there should be 11 digits in all) but consists of 10 digits. It has been observed in trials that the “rest of the number” prompt was ineffective in this just-too-short case, because it usually arose when the giver thought the 10 digits already given were a complete number. Therefore a number that is one digit too short is treated like an overlength number that cannot be repaired (as described below), i.e. the automated number transfer attempt is terminated in the fail state 242.
Too many digits given. This may indicate that one of the blocks of digits (given under condition (f) above) was intended to replace, rather than follow, the digits previously recognised and echoed. To cope with this, a finalRepair algorithm is applied 224 to the telno buffer. This final repair algorithm is described in detail below.

Once the final repair has been attempted, the telno is again tested 246. If this repair succeeds in deriving a valid telephone number (ok), this is read back 248 to the giver for confirmation. If it is confirmed by the giver with the standard completion signal criteria (silence or “yes”) then “thank you” is output 234 and the dialogue terminates 236 in the ok state returning the repaired telno buffer. If not, then no further recorded prompts are played and the dialogue terminates in the fail state.

(h) Abort. Whenever the abort signal is received (recognition totally rejected), the current dialogue is immediately terminated 242 and the dialogue returns in the fail state. Alternatively this could be treated as garbled input condition (b) if desired.

For all of these conditions, whenever a block of digits is played out to the giver, the algorithm playBlock(block,endIntonOption) is used as defined in Appendix A.

localRepair(input_block)

This occurs at 208, 226 if there are any spontaneous repairs within a single input block (e.g. “3 4 5 no 4 6”). The input_block is repaired prior to being further processed. If there are no spontaneous repairs in the input then local repair returns the input unaltered. Local repair is operated by a repair-from-end rule, in which if there are at least as many digits after the “no” as before it, the whole sequence of digits before “no” is replaced; if there are fewer digits after than before, only the last N of the digits before “no” are replaced, where N is the number of digits after “no”. (So the example quoted would be interpreted as “3 4 6”.)

immediateRepair(current_block,input_block)

The immediate correction at 224 also operates on the current_block by a repair-from-end rule, in which the digits in a “no <digits>” sequence are taken as replacing the same number of digits at the end of the current_block, or replacing the whole of the block and continuing the number if there are digits to spare. Once repaired the new current_block—including any extension of it—automatically replaces the old one in the telno buffer.

finalRepair(telno) (Step 244)

A human operator can usually interpret all number corrections from a caller in-line during number transfer by using prosodic information, but the present state of speech recognition technology does not support this. Similarity-based detection of corrections where the intent of the giver is not clear from a transcript of what they have said—automatically treating a block as a replacement for the previous block if, for instance, they differ by only one digit—is error-prone, since many telephone numbers contain consecutive blocks which are similar to each other, especially where the blocks are of only two or three digits.

For this reason, the first dialogue has a cautious strategy when interpreting potentially ambiguous corrections. If the correction is not a clear repair (e.g. An input of a string of digits in the dialogue of FIG. 2 where the input is not preceded with a clear ‘No’), it is interpreted as a continuation and simply echoed back to the giver. If the prosody of the echo is reasonably neutral, callers frequently interpret this echo as confirmation of the correction if that was their intent, or as a continuation otherwise. If these points of ambiguity are noted, then they can be used at the end of the dialogue to attempt a repair of the telephone number if it is found to contain too many digits (i.e. a likely sign that there one of our continuation interpretations was actually a correction).

The final repair algorithm therefore attempts to repair an over-length telephone number in the telno buffer by looking for a pair of consecutively entered blocks that are similar enough to be a plausible error-and-replacement pair, and deletes the first of the two if it finds them. (In principle more than one such repair could be allowed in a single number, but for simplicity the present design allows only one repair.)

The final repair algorithm is formulated in terms of blocks; in this implementation the units in which the telephone number is read out for confirmation are the same blocks as received on input. (Recall that the telno buffer stores block boundaries as well as the sequence of digits provided by the giver.)

Blocks are considered as potential replacements for all or part of previous blocks. The principle is that only a unit given by the giver can act as a repair to preceding digits.

A modified version, in which input blocks can be read back piecemeal, will be described later (see below: “Chunked Confirmation Option”).

The algorithm has five stages, as listed below. Each stage is applied only if the preceding ones have failed. Within each stage, the criterion for applying the operation is that the repair should yield a correct-length number and there should be no other way to get a correct-length number by an operation of the same kind. If at any stage the repair is ambiguous (i.e. there are two or more ways to achieve a correct-length number), the repair attempt is abandoned immediately, without trying the remaining stages.

1. Apply the basic final repair operation—i.e. delete block n-1 if block n differs from it by exactly one digit (through substitution, insertion or deletion).

2. Delete the last L(n) digits of block n-1 if these digits differ from block n by exactly one digit substitution, where L(n) is the length of block n. (This deals with end-of-block repetition following a substitution error, but it could go wrong in cases with insertion and deletion errors, especially in non-geographic numbers where the correct total length is not known.)

3. Delete blocks n-k to n-1 (where k>=1) if their concatenation is an initial sub-string of block n. (This deals with restarts in cases without a prior recognition error. The initial sub-string is allowed to be the whole of block n: so the algorithm can cope with simple repetition of part or all of the number.)

4. Delete blocks n-k to n-1 if their concatenation differs from block n by exactly one digit substitution. (This deals with a restart following a substitution error, or a late correction in which the blocks since the one with the error are repeated. It could be extended to allow the digits to differ by one insertion or deletion, to cope with restarts following insertion and deletion errors.)

5. Delete blocks n-k to n-1 if their concatenation differs from an initial sub-string of block n by exactly one digit substitution. (This deals with correction and continuation in the same block, including the case with a restart or a late repair, following a substitution error.)

Dialogue Wordings

The message wordings for the dialogue (other than echoes of digits, and the initial prompt and re-prompt which are service dependent) are listed below:

| Function | Wording |
|---|---|
| Confirm number transfer is over | Thank you! (with final intonation) |
| sorry <repaired block> | Sorry . . . (apologetic with continuing |
| | intonation for subsequent corrected |
| | number) |
| can you say that again? | Sorry (with slight question intonation) |
| prompt for rest of number | Could you give me the rest of the |
| | number? |
| request code | Sorry, what code is that? |
| so that's <repaired number>” | So that's . . . (complete number to be |
| | concatenated, with ending intonation |
| | on last block) |

Effect of Time-Out Values on Dialogue Styles in the Basic Design

By adjusting the time-out parameters for the basic dialogue design shown in FIG. 2, different styles of behaviour emerge from the design.

It is possible to enforce a “chunked” dialogue style, with a low value for T_{STD} (e.g. 0.4s) when an STD code is expected or an “unchunked” style, with the T_{STD} set to default T_{D} or longer.

With the “chunked” style, the giver will typically be interrupted immediately after giving the STD code with an echo of this code. Giver behaviour is usually such that the remainder of the telephone number is then given in chunks with the giver pausing for feedback after each chunk. In this style, the dialogue has thus primed the giver for a chunked style through rapid intervention at the start.

With the “unchunked” style, the giver will not be interrupted after the STD and is left to deliver the number until they choose to wait for the dialogue to respond by remaining silent. In this case many, but not all, givers will go on to deliver the whole number in one utterance. Whenever the giver chooses to wait for a response a full echo will be given of the utterance to this point. In this style the giver selects the chunking style they prefer, but may be unaware that there is an option.

Both of these styles always echo each input chunk completely after each input regardless of its length (although these echoes do adopt an internal chunked intonation pattern if they are longer than 4 digits—See Appendix A for details).

### CHAPTER IV: DIALOGUE, SECOND VERSION

An extension to the simple strategy is now described in which the end-of-block conditions for input are the same as in the “unchunked” case, but fully paused chunking is used during the readback of longer digit blocks during confirmation i.e. parts of giver input chunks could be grounded bit by bit rather than all at once.

The dialogue with this third strategy follows that described with reference to FIG. 2 except when an input_block (given without an initial “no”) contains more than five digits. When this happens, instead of the output being simply an echo of the whole current_block, a chunked confirmation sub-dialogue is entered, which is as shown in FIG. 4. This sub-dialogue replaces the simple “play <current_block>” (210, 218, 238) occurring in the basic dialogue and appearing in paths (c), (e) and (f) of FIG. 2. During the chunked confirmation sub-dialogue, successive chunks, typically containing three or four digits each, are echoed back to the giver; there are pauses between chunks, in which the giver can respond by confirming, contradicting, correcting or continuing the digit sequence just echoed. The first chunk in the sequence is preceded by “that's” if this is the first echo of a digit block in the current dialogue, or the first echo following a re-prompt for the whole code and number. The sub-dialogue ends with the output of the last chunk of the current_block, at which point the main dialogue resumes and possible inputs from the giver are dealt with as in Figure II.

The division of current_block into chunks is described in Appendix A and illustrated in the flowchart of FIG. 6.

Within a chunked confirmation, if the giver remains silent during an inter-chunk pause, or says “yes” or a synonym, the readback simply proceeds to the next chunk. As before, in case of a straight “no”, the telno buffer is cleared and the main dialogue is resumed with a “code and number again” prompt. The processing of input containing digits is more complex, because such input may be (i) a correction or repetition of digits that have just been echoed, or (ii) a continuation of the number, repeating and possibly continuing beyond digits that were given in the original current_block but that have not yet been echoed, or (iii) a combination of (i) and (ii). The processing of inter-chunk digit input is as follows. Note that although block boundaries and correction unit boundaries are recorded in the buffer, this information is not used until the final repair stage later.

This modified version allows more flexibility in the echoing back of digits to the giver, the idea being that longer input blocks of digits can be broken up into shorter blocks of a more manageable length for confirmation purposes. Secondly, it offers a more sophisticated treatment of the input given by the giver in response to requests for confirmation, in particular in allowing more flexibility in the interpretation of the input as being a correction, repetition or continuation of the echoed output, or a combination of these. Thirdly—as a consequence of this—it aims to preserve additional information about the history of the dialogue that has taken place, in order to continue to facilitate the correction of some of the incorrect decisions that have been taken at the “immediate repair” stage being corrected in the “final repair”.

Telno Buffer Structure—Second Version

In order to facilitate these extensions, the definition of the buffer 10 needs to be slightly extended. The progressive confirmation of sub-chunks of the current_block requires that there is a mechanism to record the parts which have been confirmed, those which are currently being confirmed, and those which remain to be confirmed. Also the fact that inputs may now span multiple output chunks needs to be recorded.

Firstly during chunked confirmation, the buffer is given the additional region remainder by separating the fᵣ pointer recording the end of the last digit sequence output (now termed ‘chunk’ rather then ‘current_block’), from a new pointer, also noting the end of the giver's input. Secondly, the starting point of the last input is explicitly noted. Thirdly, the definition of block boundaries is clarified, and fourthly the concept of Correction Units is introduced. FIG. 5 shows the structure of the extended telno buffer.

The relationships between the different regions of the buffer are described by four pointers. These are as follows:
The ‘giver start point’ fᵢ points to the start of the last giver input;
The ‘giver focal point’ f_{g} points to the location immediately AFTER the end of the last giver input;
The ‘offer start point’ fₒ is defined to be the pointer to the start of the chunk region.

The ‘receiver focal point’ fᵣ is defined to be a pointer to the location immediately AFTER the end of the chunk region. Hence:

confirmed = (0, fₒ − 1)
chunk = (fₒ, fᵣ − 1)
remainder = (fᵣ, f_{g} − 1)

The definition of chunk can be seen to be equivalent to that of current_block. Apart from the exceptional use, described below, of ‘current block’ to pass the input into the dialogue of FIG. 4, the two are in fact exactly the same thing.

In the text that follows the above relationships are considered to always hold true. Re-definition of fₒ for example, by definition means that the extent of chunk has been re-defined also.

The addition of the ‘remainder’ region can be thought of as adding an additional state—‘given’—to the states which values in the token buffer can adopt. This state represents tokens which have been received from the giver but are yet to be ‘offered’ by the receiver for confirmation.

Recall that block boundaries have already been described which record the history of the start of each block of digits which are played to the giver for confirmation—i.e. the history of the pointer fₒ. Therefore, in this extended design, block boundaries are still recorded at the start of each chunk in chunked confirmation. The only difference in this new design is that a user input can now span a number of blocks.

Finally therefore, given this difference, associated with each block boundary, are correction units (CU's). These are intended to capture the points at which inputs have been interpreted as continuations but may actually have been corrections. Thus for each location where an input is interpreted to be pure continuation after the previous chunk, a CU is recorded which captures details about the extent of this input—that is the history of the pointers fᵢ and f_{g}, on the occasions when fᵢ=fᵣ.

By definition in this extended dialogue design, a correction unit (CU) must always begin at a block boundary. It also records the number of locations forward from the block boundary that the input spans. The block boundaries and correction units (CU's) are together used to record the coarse structure of the history of the dialogue, recording the block structure of inputs, and the block structure of outputs. This information is then used during finalRepair( ).

The representation of a CU is done by referring to the block pointer of the same index which indicates its start, and giving the CU an extent which counts the number of digits form that point to the end of it. Hence
CU₅=10
   means that correction unit number five starts at block boundary five and extends 10 digits from that point. If it is set to zero then there is essentially no CU at that block boundary. In the example of FIG. 5, the giver has given two input utterances which were both assumed to continue just after the last output. One of these CU's started at block boundary 0, and lasted three digits, the second started at block boundary 1 and lasted for eight digits. There is no correction unit starting at block boundary 2. This is denoted as CU₂=0.

A single CU may correspond to a single block, or may span two or more blocks; it usually consists of a whole number of blocks, but this may not always be the case, depending on how corrections are handled. It is noted that CU's may overlap; however, in the current design, only one CU can start at any block boundary. During finalRepair( ) all Block boundaries, even block boundaries without CU's are considered as potential sites for repair, but only CU's can be used as a starting point for repair of another block. For a more detailed definition of correction units see below: “Correction Units and the finalRepair Algorithm”.

### DEFINITIONS

| | |
|---|---|
| Chunk | The chunk most recently echoed for confirmation |
| Played | Current contents of confirmed concatenated with |
| | chunk i.e. the digits that have been confirmed |
| | to date plus the ones currently in the process |
| | of being confirmed. |
| Remainder | The digits that have been received from the giver |
| | but have not yet been echoed |
| Input | The digits in the inter-chunk input, after |
| | application of any self-repair. |

### NEW DEFINITIONS

| | |
|---|---|
| Chunked | The process of confirming a sequence of digits |
| confirmation | by confirming it one small chunk at a time, |
| | pausing for input after each chunk. |
| Inter-chunk input | Something said by the giver after one such |
| | inter-chunk pause. |
| Block boundary | A boundary point in the value buffer where a |
| | chunk readout has happened sometime in the past. |
| Block | A region of the value buffer between two block |
| | boundaries, or between the final block boundary |
| | and the end of the current chunk. |
| Correction | A region of the value buffer starting at a block |
| Unit (CU) | boundary, spanning at least one whole input from |
| | the giver, and aligned at the start with at |
| | least one input from the giver. |
| Current CU | The most recent correction unit in the token |
| | buffer with a non-zero value. |

The process of FIG. 4 starts at Step 700. At Step 700, the values of fₒ and fᵣ define the current_block in Figure II and this current_block contains the last input which in the previous design would have been played out in full to the giver.

Now, at step 701, instead of playing this whole block out, we set the whole of the remainder region to cover this current_block, and re-define the current_block, now named chunk, to be empty. The function set_remainder( ) does this as follows.

Firstly, set the new pointers fᵢ and f_{g} to span the current_output as it is defined in FIG. 2.
fᵢ=fₒ
f_{g}=fᵣ

Next re-set fᵣ to the start of this input, making chunk empty, to indicate that we have not yet played anything out at all.
fᵣ=fᵢ.

Thus the remainder is now set to the last giver input. Recall that by definition, remainder=(fᵣ, fg−1).

At Step 702, a chunk is removed from the start of this remainder. The length of the returned chunk, 1en, is determined as described in Appendix A and illustrated in the flowchart of FIG. 6. The new region chunk is now re-defined to be the first 1en tokens following fᵣ.

Thus:
fₒ=fᵣ
fᵣ=fᵣ+1en

Recall by definition chunk=(fₒ,fᵣ−1). This will be the first part of remainder to be played out to the giver. A block boundary (B₀ on the first pass) is marked at the beginning of the new chunk to record this new fₒ.

At Step 703, chunk is played. If at Step 704, the remainder is null (i.e. fᵣ=fg), control reverts (705) to Figure II. Recall at this point that current_block is synonymous with chunk because they both depend on fₒ and fᵣ. Thus control will continue in Figure II now treating only the last chunk that was played as the current block.

Otherwise, if remainder is not null, the input buffer is read at Step 706. Various types of non-digit input at 707 to 709, and 713 are dealt with much as in Figure II.

Isolated ‘Yes’ inputs (Y) or silence (S) (Step 712) are treated as simple confirmation of the chunk. At step 725 the confirmed region is extended to cover the chunk region, and chunk is set to null. This is done by:
fₒfᵣ

Digits input at 710 or 711 are dealt with firstly (as in Figure II) by local repair if any internal correction at 714. It then moves on to the alignInput function of Step 715.

alignInput(chunk,played,remainder,input)

This function (see FIG. 7) returns the value k, which is the number of digits of chunk which would be replaced given the lowest-cost alignment of the n digits in input against a concatenation of played and remainder, where the cost is the number of digit substitutions. k=0 signifies a pure continuation is the lowest cost interpretation of the input. k=n signifies that the whole input is a correction of digits which have already been played.

This process takes the input and:

1. Compute the alignment distance d₀ with k=0, i.e. for the “pure continuation” interpretation of the input. (If input is a contradiction—i.e. (via Step 710 rather than 711) prefixed by ‘N’—then this step is skipped as it is assumed that input must contain an element of correction in it).

2. For k from 1 to n, compute the alignment distance dₖ (for the interpretation in which the first k digits are repetition or correction of the final digits in played and, if k<n, the remaining n-k digits are continuation into and maybe beyond the digits in remainder).

3. Choose the value of k with the smallest alignment distance. If there is a tie, larger values of k are preferred to smaller ones, except that pure continuation (k=0) is preferred to a mixture of repetition/correction and continuation (0<k<n).

The “alignment distance” dₖ is the number of substitutions needed to convert between the input string and the string against which is it being aligned (composed of the last k digits in played and the first n-k digits in remainder). If k exceeds the number of digits in played, the excess digits at the beginning of the input are treated as being inserted at the beginning of the echoed number, and the insertions are penalised like substitutions: i.e. each inserted digit contributes 1 to the alignment distance. If n-k exceeds the number of digits in remainder, the excess digits at the end of the input contribute nothing to the alignment distance, i.e. continuation beyond what has previously been given is not penalised.

With the special exception of insertion at the start of played; the embodiment described with reference to FIG. 4 only considers the possibility of substitution by the input for current values in played. A version in which insertions and deletions are possible will be described later. In the current embodiment, the cost of substituting in the different regions of the buffer is uniform. In an alternative embodiment, it could be desirable to weight the cost of a substitution according to what state the token being substituted is in. For example the following weights could be used:
Wconfirmed=1.3 (for the confirmed region)
Woffered=1.0 (for the offered region i.e. chunk or current_block)
Wgiven=0.9 (for the remainder region).

If these weights were used then it would cost more to align differing tokens in the confined region than the offered region for example. This is because it has been confirmed and the input is thus less likely to be a correction of this region. Correction of the given region could be cost less because there has been no attempt to ground it yet.

Also, it is possible to use specific weights for certain symbols. This technique is well known in the application of DP matches. For example there may be an acoustically unique symbol with great importance which can be used as an anchor in the match. Take the ‘slash’ (/) and ‘colon’ (:) symbols in internet URL's for example. They are both acoustically strong which means that the recogniser is likely to get them right often. They also denote important structure in the input. By giving the slash and colon a higher substitution cost, e.g. 2, we can ensure that any corrections of regions of the buffer are highly likely to align with these symbols. These symbols may also be very important when splitting-up regions of the buffer for chunked confirmation.

Using the Aligned Input

Once the best value of k has been determined, then an appropriate dialogue response is required. FIG. 7 shows this situation. Essentially it is a more sophisticated version of the “immediate repair” described with reference to FIG. 2. I1 is now intended to replace C2 and I2 will replace R1. However it is possible that I1 and C2 are identical (i.e. the giver has repeated some of the chunk to give positioning to the correction). If this is the case I1 is not a repair for C2 and thus the dialogue need not treat it so. More precisely:
I1 is the first k digits of Input
I2 is the last (n-k) digits of Input
C1 is all of Chunk except the last k digits (or null if k>=the length of Chunk)
C2 is the last k digits of Chunk (or the whole of Chunk if k>=the length of Chunk)
R1 is the first (n-k) digits of Remainder (or the whole of Remainder if (n-k)>=length of Remainder)
R2 is all of Remainder except the first (n-k) digits (or null if (n-k)>=the length of Remainder)
   or notated as co-ordinate pairs in the buffer:
C1=(fₒ,fᵣ−k−1)
C2=(fᵣ−k,fᵣ−1)
R1=(fᵣ,fᵣ+n-k−1)
R2=(fᵣ+n-k,f_{g})

If any of these duples has an end index that less than the start index it is considered to be ‘null’.

updateBuffer(k)

Returning to FIG. 4, firstly, at step 716, the values in the telno buffer are updated with their new values from the input given the selected alignment value k.

If k is zero, i.e. a pure continuation, then the new giver start point fᵢ will be set to the receiver focal point (fᵣ).

If k is non-zero and the length of I1 is equal to or shorter than the length of chunk, i.e. the chunk is partially or fully corrected, then the new giver start point will be set to the start of I1.

If k is non-zero and the length of I1 is longer than chunk, i.e. a full correction of chunk with insertion at the start of chunk, the current remainder needs to shifted up to make room for the insertion, and fᵣ and f_{g} must be corrected accordingly.

In all three cases, once the new giver start point (fᵢ) has been determined and the buffer stretched if necessary, the new input needs to be copied into the buffer at this new fᵢ, and the extent of remainder extended if it has gone beyond the corrected f_{g}.

In the following pseudo-code for the function updateBuffer(k), the variable ‘ins’ is used as a temporary variable to note the length of an insertion if one is found. The return value ‘CUstate’ is used in the next function reComputeCU's to decide how to change the CU values.

if (k==0) { ** Pure continuation. CU condition A **

fᵢ=fᵣ
CUstate=“A”

}
elseif (k<=(fᵣ−fₒ)) { ** Correction of part or all
of chunk. CU condition B **

fᵢ=fᵣ−k
CUstate=“B”

}
elseif (k>(fᵣ−fₒ)) { ** Correction of all and insertion
before chunk. CU condition C
**

fᵢ=fₒ
ins=k−(fᵣ−fₒ)
telno.value(fᵢ+ins .. fg−1+ins) = telno.value(fᵢ .. f_{g}−1)
fᵣ=fᵣ+ins
f_{g}=f_{g}+ins
CUstate=“C”

}
telno.value(fᵢ .. fᵢ+n−1) = input(0 .. n−1)
if( (fᵢ+n)>f_{g}) {f_{g}=fᵢ+n}
return cuState

reComputeCU's( )

Using the CU state calculated at step 716, Step 717 modifies the correction units if necessary. The rules for doing this, and the reasons underlying these rules are described in detail later in section ‘correction units and the final repair algorithm’.

Deciding the Next Chunk.

After changing the values in the telno buffer, and updating the correction units, the following three conditions are managed by the dialogue to keep this correction grounding understandable by the giver:

(a) Chunk has changed (I1≠C2) or input is an explicit contradiction (i.e. starting with ‘N’). This condition is recognised at Step 718, exit “Yes”.

In this instance (Step 719), the current chunk is set to span C1 plus the whole of the input (C1+I1+I2) and remainder is set to be R2. Pointer fᵣ is thus moved to the start of R2. Then an announcement is played, “sorry” (Step 720) followed by echoing of the corrected chunk in its entirety at Step 703. N.B It is possible for I1 to be longer than C2 (and hence C1 is empty) due to the alignment backing-off into earlier played digits than the current chunk.

Hence:
fₒ=fₒ (i.e. unchanged)
fᵣ=fᵣ+n-k

As fₒ is unchanged, no new block boundaries are created in this case.

(b) Chunk hasn't changed (I1=C2) and I2 is 1-5 digits (Step 718, exit “No”; Step 722, exit “Yes”).

In this case the current chunk is considered confirmed, and the continued part of the input I2 is prepared to be played out as the next chunk.

Thus in step 721, confirm(chunk), the pointer fₒ is moved to just after the end of chunk.
fₒ=fᵣ

Then at Step 723, the next chunk is then set to span I2 and, the new remainder becomes simply R2 again by:
fᵣ=fᵣ+n-k

As fₒ has changed, a block boundary is set with the value of fₒ. This next chunk is echoed in its entirety at step 703.

(c) Chunk hasn't changed and I2 is empty or more than 5 digits (Step 718, exit “No”; Step 722, exit “No”).

Again, the current chunk is confirmed at step 721, so the pointer fₒ is moved to just after the end of chunk (fₒ=fᵣ). In this case, I2 has got too big to confirm as a single chunk. Instead, remainder is set to be I2 plus R2, Hence:
fᵣ=f_{g}

The process returns to the standard process (Step 702) of finding the first chunk in it to be confirmed, and as fₒ has changed, a block boundary is set with the value of fₒ (this is what addBoundary(chunk) does).

FIG. 8 illustrates the above by showing how and when new block boundaries are created. N.B. In case (a) a new chunk is created which overlaps the previous chunk but there is only one block boundary.

Correction Units and the finalRepair Algorithm (Second Version)

Correction Unit Definition

Conceptually a CU represents a block of digits as input by the giver. That is to say in the simple case the region stretching from fᵢ to just before f_{g}. However, inputs can themselves be interpreted as corrections or repetitions of information input in previous utterances. In this case the original correction unit may be retained, but altered, and maybe lengthened, by this new input

FIG. 7 shows the confirmed values, the current chunk being grounded, and the remainder values to be grounded as discussed in the previous sections. As already described these three buffers can be thought of as a single buffer telno which is broken into different blocks. Each block has a start point denoted by the boundaries B₀ . . . BM_{M-1}. A block is taken to stretch from one block boundary to the next block boundary or the end of the buffer contents if there is no next boundary. The primary thing to note is that block boundaries are recorded wherever a chunk starts in a new place in the telno buffer. Under condition (a) in the preceding section, chunks can be written and re-written over the same portion of the buffer without creating any new block boundaries. When a new block boundary is created, then the region between it and the previous block boundary becomes a block. Hence chunks are the same as blocks if the giver remains silent, confirms or continues at inter-chunk boundaries, but they can be very different if the speaker ever backs-up to make a correction or repetition.

The finalRepair algorithm (second version) described above uses the concept of Correction Units (CU's) which are used to repair the telephone number when it is found to be over-length.

Conceptually a CU represents a sequence of digits as input by the giver which lines up with the start of a sequence of digits offered as output. It has already been noted that, for the simple unchunked case, if an input is an explicit correction, the resultant repaired block becomes a CU which replaces the original one and this whole new CU is used as the output for the next confirmation. Block boundaries in such a case will always line up with the start of CU's. For CU's arising other than from inter-chunk inputs in chunked confirmations, this basic definition is all that is needed.

In the chunked confirmation case, there can be one correction unit starting at each block boundary, namely CU₀ . . . CU_{M-1}. These correction units are represented as an integer number of tokens counting forward from the block boundary. However only some of the blocks have a correction unit (CU) associated with them. Those without are represented as CU_{Y}=0. Correction units can overlap, and need not end at block boundaries.

By way of example in the diagram (FIG. 7) block 0 has a correction unit, CU₀, spanning to the end of the token buffer. CU₁ and CU₂ are not present (i.e. zero), denoting the fact that a continuing input from the giver has only happened at the start of the first block

In the following sections examples will be given. The notation used for these examples is defined as follows:
N=no.
C=correction acknowledgement: “sorry” (preceding echo of block).
S=silence
Y=“yes” or synonym
* is not part of the dialogue—it indicates to the reader that the digit preceding it has been misrecognised.

Examples of dialogue turns are given, when not tabulated, in the form of the string recognised as received from the giver, a hyphen, then the string spoken by the system.

CU's and Non-Chunked Confirmation (cf. FIG. 2)

In the basic dialogue with no chunked confirmations as shown in FIG. 2, there is one CU for every block, and CU's always span a single block exactly. The variable current_block can be considered to play the same role as chunk in the chunked confirmation. The rules for CU's in these circumstances are

A New CU's are created whenever an input is interpreted to be a pure continuation. This entire input will become a current_block to be played out. A block boundary is thus inserted at this point.

B When a repair is given by repeating only the end of the just-echoed “chunk”, the CU is unchanged. An apology will be given to the giver and the current_block, set to the new value of this corrected CU, will be played out: e.g. in “123-124* N23-C123” the repaired CU is “123”. Also after a repair and continuation in the same utterance, no new CU is created but the CU is extended to cover the entire input: An apology will be played out, and the current_block will be set to the value of this extended CU and played out. e.g.:“123-124* N123168-C123168” yields a CU “123168”.

CU's and Chunked Confirmation (cf. FIG. 4)—Summary

In the case where chunked confirmation is used, the definition of CU's becomes more complex. Basically, when a digit string is received from the giver it is gradually broken into chunks for output one at a time as the chunked confirmation evolves. As described, separate block boundaries are marked in the buffer as the confirmation evolves. Initially the whole input string is a single CU since it was given by the giver in a single utterance. However, this CU can be modified and additional CU's can arise from inter-chunk inputs (cf. FIG. 4).

Correction Units are intended to capture the regions of the telno buffer which have been interpreted in one way, but may actually have been a repair of a preceding blocks before them. Thus they can only start at points that co-incide with the start of input utterances. This is because any other interpretation will not have remained ambiguous in the dialogue and hence will not be useful during final repair.

reComputeCU's(k, CUstate)

As will be seen in the subsequent description, the CU's are directly associated with fᵢ and f_{g} when they are created. Sometimes however an input will extend an existing CU rather than create a new one so there is not a 1:1 correspondence between input and correction unit.

On creation, if it is a simple CU, then the start of the CU would be fᵢ and it would extend (f_{g}-fᵢ) digits in extent. However due to the CU rules, the CU start point will not be changed, but it could be extended to a later f_{g} point if necessary. Hence a CU's index number identifies its immutable start point, but its extent may be modified by a later input.

CU's are altered or new CU's generated by the function reComputeCU's(k) in step 717. This function extends the two rules we have for the unchunked case above, and adds an additional rule. These three rules correspond to the CUstate's returned by the function updateBuffer( ) in step 716. The rules are all based on the value of k and the length of chunk as follows:

A. (k=0). The input has been interpreted as a pure continuation from the end of chunk. This input becomes a new correction unit (CU). The initial part of, or all of the input will be echoed back to the giver as the next chunk.

Thus given that current ‘chunk’ starts at block boundary Bₓ (=fₒ) and ends at index (fᵣ−1), and fᵢ=fᵣ because k=0, then:
CUₓ₊₁=f_{g}-fᵢ

This input may actually have been a correction rather than a continuation and hence its status as a correction unit.

B. (k<=length(chunk)). The input is interpreted as a partial or exact replacement or correction of the chunk, with a possible continuation.

This condition does not create a new CU, but it does extend the current CU to span the whole of the current input if it does not already do so.

Thus given that current CU is CU_{Y} which starts at block boundary B_{Y} (recall that the current CU is the last NON-ZERO correction unit and thus there may be block boundaries following the start of the current CU),
if (CU_{Y}<f_{g}-B_{Y}) then {CU_{Y}=f_{g}-B_{Y}}

If it was a correction, the receiver will hear a ‘sorry’ followed by the corrected chunk. (condition (a)). If it was a repetition, the initial part of, or all of the continuation will be echoed back to the giver as the next block.

If the interpretation was correct then the correcting function of this input has already taken effect, so it will not require a CU to allow it to have a correcting function. If the chunk already had a possible correcting function there will already be a CU there, and the original CU will itself be corrected by this input. If this interpretation was wrong, then the next prompt will make it clear that an incorrect interpretation has been made and the giver has an opportunity to correct it.

C. (k>length(chunk)). The input is interpreted to completely replace the chunk and also inserts additional digits at the block boundary where before the chunk. Continuation may well be present also. This is a special case due to the fact that alignInput( ) only repairs the current chunk when the input has actually aligned further back into preceding values in the buffer.

A new CU is created if there is not a pre-existing one at that boundary. If this CU does not span the whole input it is extended to do so.

Thus given that the current ‘chunk’ starts at block boundary B_{X}(=fₒ) and ends at index (fᵣ−1):

if (CU_{X}==0) { CU_{X}=f_{g}−B_{X} }
else if (CU_{X}<f_{g}−B_{X}) then { CU_{X}=f_{g}−B_{X} }

The giver will hear “Sorry” followed by an echo of the whole of the current input. Hence it will be clear that this input has been treated as a correction of preceding digits.

As there has been an insertion at block boundary, this CU is very likely to actually contain a measure of correction of a previous block. Repair of this mistake can occur at finalRepair( ).

Final Repair

The finalRepair algorithm described earlier can be modified to use the concept of Correction Units (CU's) in order to repair the telephone number when it is found to be over-length.

In this case the numbered steps given previously are replaced by the following:

1. Apply the basic final repair operation—i.e. delete block n-1 if CU n differs from it by exactly one digit (through substitution, insertion or deletion).

2. Delete the last L(n) digits of block n-1 if these digits differ from CU n by exactly one digit substitution, where L(n) is the length of CU n. (This deals with end-of-block repetition following a substitution error, but it could go wrong in cases with insertion and deletion errors, especially in non-geographic numbers where the correct total length is not known.)

3. Delete blocks n-k to n-1 (where k>=1) if their concatenation is an initial sub-string of CU n. (This deals with restarts in cases without a prior recognition error. The initial sub-string is allowed to be the whole of CU n: so the algorithm can cope with simple repetition of part or all of the number.)

4. Delete blocks n-k to n-1 if their concatenation differs from CU n by exactly one digit substitution. (This deals with a restart following a substitution error, or a late correction in which the blocks since the one with the error are repeated. It could be extended to allow the digits to differ by one insertion or deletion, to cope with restarts following insertion and deletion errors.)

5. Delete blocks n-k to n-1 if their concatenation differs from an initial sub-string of CU n by exactly one digit substitution. (This deals with correction and continuation in the same block, including the case with a restart or a late repair, following a substitution error.)

The finalRepair( ) algorithm implements the principle that the tokens following a correction unit boundary that can credibly be considered to be contiguous, may in fact be a repair for tokens which occur before that boundary. A second principle that is used in the finalRepair algorithm is that, based on behavioural observations, giver correcting inputs will tend to either start or end at a block boundary. In the current implementation the block boundaries are those imposed by the receiver, attempting to adopt giver start points as block boundaries wherever a continuation interpretation is made.

These principles could be implemented by different algorithms which differ in detail, but not intent, over the algorithm described above. For example the algorithm already adopts an approximate interpretation of the alignInput( ) algorithm, but with differences. It does look for possible insertion and deletion errors. It does not however currently exhaustively explore all alignments. Instead, for the reason stated above and for efficiency, it biases the search towards block boundary decisions. The algorithm could be straightforwardly extended to allow a full DP match during finalRepair.

As has been seen in the test(telno) function, it is also a possibility to define a grammar (for example a regular expression) to describe what a complete telephone number looks like. Then, the decision as to whether a particular repair option is successful or not may be made according to whether the resulting buffer contents match this grammar or not.

### EXAMPLES

(The notation used here is as defined earlier)

### Example 1

### Restart From Earlier Block—Full Repair of Last Chunk

| Giver | Interpretation | System |
|---|---|---|
| 01234567890 | A | thats_01234 |
| S | | 568* |
| N01234567 | C | C01234567 |
| S | | 890 |
| S | | |

After this the blocks in telno are 01234 01234567 890 and the CU's are 01234012345, starting at the first block, and 01234567, starting at the second block. The first CU was created at the first utterance and its length is unchanged although its content has been changed; this looks anomalous, but shouldn't matter, especially in a case like this where it is at the start of the number. (The CU at the first block is never used since there is nothing before for it to correct.) The second CU was created by the correcting input after the recognition error; it will be used in final repair so that the first block gets deleted. The repair succeeds at stage 3.

### Example 2

### Restart From Earlier Block Outside the Chunked Sequence, with Continuation—Full Repair of Last Chunk

| Giver | Interpretation | System |
|---|---|---|
| 01234 | A | 01234 |
| 567890 | A | 54*7 |
| 01234567890 | C | C01234567890 |
| Y | | |

The blocks after this are 01234 01234567890, and the CU's are the same. The repair succeeds at stage 3.

### Example 3

### Continuation Misinterpreted as Repetition, Followed by Correction Misinterpreted as Continuation

| Giver | Interpretation | System |
|---|---|---|
| 01234123123 | A | thats_01234 |
| S | | 123 |
| 123 | B | 124* |
| 123 | A | 123 |
| S | | |

This results in blocks 01234 123 124 123, and CU's 01234123124 (from original input, with last digit misrecognised) and 123 (from last input). Final repair succeeds, because the block 124 is not a CU and so it can't create a repair ambiguity by being a candidate to replace the preceding 123. The repair succeeds at stage 1.

### Example 4

### Correction Misinterpreted as Continuation, Followed by Third-Block Repetition Misinterpreted as Fourth Block

| Giver | Interpretation | System |
|---|---|---|
| 01234123123 | A | thats_01234 |
| S | | 125* |
| 123 | A | 123 |
| Y123 | A | 123 |
| S | | |

This yields blocks 01234 125 123 123, with CU's 01234125123 (from the original input), 123 (from the inter-chunk input, overlapping with the first CU) and 123 (from the last input). Stage 1 of final repair will delete the block 125 in favour of the CU 123 that follows it.

### Example 5

| Giver | Interpretation | System |
|---|---|---|
| 01234567890 | A | That's_01234 |
| S | | 567 |
| S | | 890 |
| 01234567 | A | 01238* |
| N34567890 | B | C01234567890 |
| Y | | |

After this the blocks are 01234 567 890 01234567890 and the CU's are 01234567890 (at the beginning) and 01234567890 (from the second input type A, extended by the third, type B). Stage 3 of final repair will replace the whole of the first CU.

### Example 6

| Giver | Interpretation | System |
|---|---|---|
| 01234567890 | A | That's_01234 |
| S | | 567 |
| S | | 890 |
| 01234567890 | A | 01238* |
| N34567890 | B | C01234567890 |
| Y | | |

After this the blocks will be 01234 567 890 01234567890 and the CU's will be 01234567890 and 01234567890. Stage 3 of final repair will replace the whole of the first CU with the second CU.

### Example 7

| Giver | Interpretation | System |
|---|---|---|
| 01234567890 | A | That's_01234 |
| S | | 567 |
| S | | 88*0 |
| 01234567890 | A | 01233* |
| N01234 | B | C01234 |
| S | | 567 |
| S | | 890 |
| Y | | |

This yields blocks 01234 567 880 01234 567 890, with CU's 01234567880 and 01234567890. Stage 4 of the final repair will replace the first CU with the second.

### CHAPTER V

Other Possible Dialogue Variants

Possible variations on the above dialogues include the following.
In the first simple variant of the dialogue, it would be possible to interpret every input as a continuation (i.e. echo everything received back to the caller, possibly with a ‘sorry’ preceding all utterances starting with ‘no’). These can become new blocks, and the finalRepair( ) algorithm used to decide the correct interpretation at the end. Blocks derived from an utterance containing ‘no’ could be noted and the final repair could insist that they have a correcting function, or bias choice of alternative corrections towards those interpretations with these utterances having correction functions. This approach may be especially beneficial in circumstances where it is difficult to do the interpretation between inputs for reasons of speed or technical architecture.
If there is a missing STD code with a full body following a completion signal and the caller CLI is available, it might be best to guess the code from the caller's code. In the trial CLI was not available so we used the strategy of explicitly asking for the code instead.
On straight “no” , the system could clear only the current_block, apologise and ask for a repeat of the block: either “sorry! could you repeat that” if after first block output or “sorry, can I have that bit again” if after subsequent block outputs. This would have the advantage of requiring less repetition by the giver, but the disadvantage of possible confusion as to what “that bit” refers to.
The repair algorithm could be modified, for the self-repair case (“<digits> no <digits>”) or the correction-of-echo case (“no <digits>”) or both. In particular, when there are fewer digits in the replacement block (after the “no”) than in the block being corrected, the present algorithm replaces only the end of the original block. A simple alternative is to replace the whole of the original block; but this yields the wrong result—in a way that may not be obvious to the giver—where the giver is correcting an error in the last chunk of a block (containing two or more chunks) without repeating the earlier digits in the block. More sophisticated strategies could be devised, replacing the whole block or only the end of it according to the degree of similarity between the replaced and replacement digit strings or according to heuristics based on block length. The present algorithm has the advantages of simplicity and explicitness (it should be clear to the giver that the block echoed after the repair, which is always at least as long as the block echoed before it, is intended to replace the whole of that block); its disadvantages are that a correction of the early part of a block will be misinterpreted if followed by a pause and that it is very difficult for the giver to correct an overlength block at the end of a number (the only way to do this is to give a straight “no” or garbled input which causes the system to clear the buffer and start again).
In the case where, on receiving a completion signal or silence, the first block in the buffer does not start with “0” but the last block does, the software could test whether a complete number can be obtained by moving the last block to the beginning and, if so, treat the accumulated input as a complete number. The dialogue could optionally offer the rearranged number for confirmation, as it already does in the case of a repaired number after entry of too many digits.
“Thank you” could be added as an explicit completion signal immediately following the echo when the digits given so far constitute a complete number. This should work well, and would correspond to the most common pattern in human operator dialogues, when there had been no error and correction during the number transfer; but it could confuse the giver in the case where one of the blocks given was actually a replacement for the preceding block and the number was therefore not complete. The more subtle completion signal adopted in Figure II Oust a change from continuing to ending intonation in the echo) seems less likely to cause such confusion. The “Thank you” message is given only after a completion signal or silence from the giver.
The repair-from-end strategy of immediate repair is usually successful, but it fails in the minority of cases where the giver repeats only a non-final part of the previous block. The problem with non-final partial repetitions would require a similarity-based correction strategy, in which the digits after “no” would be taken as a correction for the part of the previous input that they most closely resembled.
The repair-from-end rule will also fail in cases with insertion and deletion errors (artificially excluded from the trials to date, but occurring occasionally as wizard errors), since it assumes that the correcting digits must replace the same number of digits in the previously recognised input. Here again, similarity-based matching might be required.

### CHAPTER VI

FIG. 9 is a modified flowchart which essentially integrates the functionality of the two flowcharts of FIGS. 2 and 4 to give a generalised solution to the problem. It has two possible start-points.

The first—start(initial)—notes that is not essential that the original input that is now to be read back and confirmed by means of a spoken response should itself actually have been generated from a speech input. Thus the process shown in FIG. 9 could be applied to input from another source. One example of this, in the context of a telephone number dialogue might be where the system obtains a number (or part of a number such as the STD code) from a database, or perhaps assumes that the code will be the same as the user's own STD code, but needs to offer it for confirmation in case it has “guessed” wrongly.” This can be done by using the start(initial) route and setting initial to the assumed ‘STD’. The giver can then confirm this, correct it, or continue to give the number in the same fashion described previously.

The second—start(“”)—starts with an empty buffer and asks an initial question to elicit an answer. This represents the normal operation described to date.

Another difference in FIG. 9 from previous embodiments, is that once the telephone number has been successfully repaired, it is again offered for confirmation using the same algorithm. This is directly equivalent to re-starting the algorithm at start(initial) and setting the ‘initial’ value to be the repaired telephone number. It can thus be seen that this invention can be used for the input of unknown information or for the confirmation of possibly uncertain information in the same framework.

### CHAPTER VII—DIALOGUE, FOURTH VERSION

With the special exception of insertion at the start of played; this embodiment described previously only considers the possibility of substitution by the input for current values in played. In fact, observed speech recognition errors for digit recognition are more likely to be substitutions than insertions or deletions. However, insertions and deletions are possible, and this algorithm is capable of being general for any token sequence such as alpha-numerics (e.g. post-codes) or even natural word sequences (e.g. a simple dictation task). The alignInput algorithm can be straightforwardly extended to consider insertion and deletion errors. One such method to do this is to use dynamic-programming alignment (DP matching), such as the algorithm described in our International patent application WO 01/46945, or any other DP alignment algorithm as is well known to those skilled in the art. If insertions and deletions are to be allowed in alignInput then, in the following description, the update of the buffer pointers following input, the re-assignment of correction units, and the block boundaries, all need to take into account the insertion and deletion effects. This can straightforwardly be done by shifting the pointers following the modification point to the left following deletions and to the right following insertions.

In this embodiment of the invention, a modified token buffer is used. This stores the current hypothesis about the token sequence being transferred between giver and receiver, and also the current state of the dialogue grounding state. The buffer is a sequential list of tokens (words, digits, letters etc), each token has an index reference number, a state and a value. Special values may also be used to store phrase boundary information. FIG. 10 shows an example token buffer state for a partially grounded telephone number, including the special start token and special phrasal boundary token ‘#’. The token buffer structure also has a cost associated with it. The cost of an empty buffer is initially zero. Note that the use of the phrasal boundaries is optional, as also is the use of a cost field for the token buffer.

The token grounding dialogue is designed to act as the receiver in the dialogue filling this buffer sequentially by taking digit inputs from a giver, attempting to ground these digits and responding to corrections during this grounding.

In order to do this it must store the grounding state of each token as well as its value. Table 5 shows the different states, and sub-states which a token can be assigned. Initially a token is ungiven (S) and generally has no value, although in certain circumstances it may be desirable to assign an initial value if there are strong prior expectations as to what sequence is expected. Once a value has been given by the giver for a token it moves into the state given(1). If this is the first time this token has been discussed it will be given-initial(1_{A}). If it is a correction of a previously given token it will be given-corrected (1_{B}). Once a token has been reflected back to the giver by the receiver it becomes grounded-offered(F_{A}), once it has been acknowledged by the giver it then becomes grounded-confirmed(F_{B}). These states are an extension of the scheme proposed in “Speech Acts Approach to Grounding in Conversation,” Proceedings 2nd International Conference on Spoken Language Processing (ICSLP-92), pages 137-40, David R. Traum and James F. Allen.

TABLE 5
Possible token states in the token buffer.

| State | Sub-state | Name | Description |
|---|---|---|---|
| S | | Ungiven | Token has not been given yet. |
| | | | (start state) |
| 1 | 1_{A} | Given-Initial | Token is given by the giver |
| | | | but un-grounded. |
| | 1_{B} | Given-Corrected | Token re-given by the giver |
| | | | with a corrected value. |
| F | F_{A} | Grounded-Offered | Token echoed by receiver |
| | | | for grounding. |
| | F_{B} | Grounded-Confirmed | Token fully confirmed by |
| | | | giver by either ‘yes’ |
| | | | or by repetition. |

In order to keep track of the dialogue state, the token buffer also contains four pointers. Two of these are the giver focal point—f_{g}, and the receiver focal point—fᵣ. These two, f_{g} and fᵣ, are used to note the focal point in the token sequence at the end of each dialogue turn (giver and receiver). They indicate in the buffer the token immediately following the token where the last turn ended for each participant i.e. the token which would have been input next had the speaker continued.

Two additional pointers are recorded. These are the giver start point fᵢ and the receiver start point fₒ. These point to the token in the buffer where the last turn of each of these speakers began. Thus, immediately following a turn by the respective participant, the last input from the giver can be taken to be tokenbuf[fᵢ . . . f_{g}−1] and the last token sequence echoed by the receiver will be tokenbuf[fₒ . . . fᵣ−1].

This information can usually, but not always, be inferred from the states of the tokens in the buffer. As the dialogue system is the receiver then fₒ and fᵣ are always accurately known. Following the echo of a token sequence by the receiver, the tokens just echoed will be set to state F_{A}. The receiver start point will be the start token of this sequence of states and the receiver focal point fᵣ will be the token after this sequence of states. In the case of the giver, the supposed alignment of the input with the current state of the buffer has to be decided. This decision is used to mark where the giver input is believed to start—fᵢ and end—f_{g}. Typically f_{g} will be at the end of a sequence of tokens in the buffer in state 1A.

In the following description the following notation will be used:
buffer[a . . . b]—The values and states of the buffer between index a and b
buffer.value[a . . . b]—The array of buffer values between index a and b
buffer.state[a . . . b]—The array of buffer states between index a and b
tokenbuf.score—The global score of the buffer.

In cases where the subscripts are omitted then the whole extent of the buffer is used. e.g:
buffer—The whole buffer including states and values and cost.
buffer.value—The array of all the values in the buffer
buffer.state—The array of all the states in the buffer

Note that this buffer structure is used throughout this embodiment to store sequences of tokens in various contexts. It is not just used for the token buffer itself. For example the input returned from the recogniser is stored in this structure and also intermediate values in processing algorithms use it as well.

FIG. 11 shows the flow diagram for a telephone number grounding dialogue. Broadly speaking the purpose of this dialogue is to gather and ground input from the giver into the token buffer. This will continue as long as the giver wishes to give more tokens. Then the resulting buffer is matched to pre-defined patterns to check for completeness, repaired if necessary, and returned with a status to the calling application.

In slightly more detail the algorithm has the following cyclical pattern.

An input is received from the giver. This input is then interpreted—with reference to the current token buffer—to decide which tokens in the buffer are to be updated by the new input. The interpretation has a cost of match associated with it. Once this interpretation is decided then the buffer is altered to give it new tokens in altered states. The cost of the buffer is increased by the match cost. Then the start and focal indexes for the giver are updated.

The updated token buffer is then classified as ‘ungrounded’, ‘matched’ or ‘repaired’. The ‘ungrounded’ state means that there are still tokens in the buffer which have not been fully agreed (grounded) between the giver and the receiver. i.e. they are in the ‘given’ state. In this case these ungrounded tokens (plus any appropriate context) will be offered by the receiver back to the caller. One of the main purposes of this invention is to manage this repetition process and ensure at all times that the giver and receiver are synchronised.

The ‘matched’ category occurs when there are no ungrounded digits left in the buffer. The sequence of grounded token values is matched against a pattern to check whether a complete sequence has been received. If not, other patterns are tried to identify why the token sequence is incomplete and corrective action is taken in the dialogue—eliciting further tokens for grounding.

The ‘repaired’ category is tried when the grounded buffer does not match any of the patterns. In this case an attempt is made to repair the buffer by looking for other plausible token sequences given the dialogue history to date. If this is possible then the repaired buffer is matched against one or all of the grammars as above. If no match can be found to a repaired buffer then the process ends with a failure condition. If a match can be found for the repaired token buffer—then the token buffer is re-grounded to make sure that the repair was correct.

After each turn which does not result in a conclusion the users input is gathered and the cycle is repeated. This continues until a successful transfer occurs or the dialogue ends in failure.

The following sections discuss this process in more detail. As described above the algorithm is cyclical. The detailed description of the algorithm begins at the start point of FIG. 11 by describing how the algorithm responds to the current status of the token buffer. Recall that in most use-cases the token buffer will initially be empty but it could be given a value if the application so desired—for example if the system already had an uncertain telephone number it wanted to confirm with the user. An empty buffer is one where the special ‘start’ token in the grounded state is at index zero. This represents the agreed starting point for both the given and the receiver. All other tokens are empty in the ungiven state. All pointers point to index 1 (i.e. the first empty ungiven location).

The algorithm begins at Start point 1102. A first pass through the dialogue will now be described, but description of those alternatives that are not relevant to the first pass will be deferred until later in the narrative. We assume that the token buffer is initially empty. The pointers fₒ, fᵣ, fᵢ, f_{g} are all one. At 1104 the status of the token buffer is examined and the buffer is found to be empty, so the algorithm proceeds at step 1106 to play an announcement asking for spoken input from the giver (on the first pass through the flowchart the word “again” is suppressed). At 1108 the giver's input is received by the recogniser. Assuming successful recognition of digits, path (f) is taken, leading (if necessary following local repair 1110, which is performed as described above) to an “interpret input” step 1112. Given that the token buffer is empty, this step simply serves to copy the digits contained in the input buffer into the token buffer, to record such digits as being in State 1A, and to set the pointer f_{g} to point to the next ungiven location in the token buffer (i.e. if 6 digits have been entered, f_{g} will be set to 7); the other pointers remain at one. The process then returns to 1104 for another pass. For description of addCP(tokembuff) 1113 see “Final Repair” below.

The state of the token buffer is used to decide what the receiver should say next. At the start of the dialogue and after every giver dialogue turn, the status of the buffer is checked in Step 1104 using function Status(tokenbuf). Grounding status is checked and grammatical criteria are used for completion tests and repair.

Determining the status of the token buffer is done by following the flow diagram shown in FIG. 12. The buffer is first tested 1201 to see what its grounding state is. If it contains any ungrounded tokens then it is considered ungrounded 1202. This means that the contents of the buffer has not yet been fully agreed between the giver and the receiver. This will usually be the case until the giver gives a completion signal—such as ‘yes’ or remains silent at the end of a sequence of digit transfers. It can happen in other ways—the most special being the initial condition where the initial empty buffer is considered to be fully grounded and then matched against an empty pattern to kick the whole algorithm off. Ungrounded buffers are then further categorised into one of four ungrounded sub-states. These ungrounded sub-states are returned as the status of the token buffer.

If the whole buffer is found at 1203 to be grounded then its confirmed contents can then be matched against the grammar patterns to decide what to do next. If any grammar patterns are found to match then the name of the matching grammar is returned at 1204 as the status of the token buffer.

If no matching grammar is found then an attempt is made at 1205 to repair the buffer to make it match one of the grammars. If this succeeds then the name of the repaired grammar is returned as the status of the token buffer.

If none of these succeed then the status of the token buffer is considered to be nomatch at 1207.

Table 6 summarises the truth table for deciding, at 1201 in the function groundingState( ), on the grounding state of the buffer. The grounding states indicated in the table are selected if the results of the four Boolean tests shown in the table match the pattern for that grounding state.

TABLE 6
Truth table to determine the grounding state
of the token buffer. (x = either 0 or 1)

| Grounding | | | | 1_{A}, 1_{B}, F_{A} |
|---|---|---|---|---|
| State | 1_{A} before fᵣ | 1_{B} before fᵣ | f_{g} < fᵣ | after fᵣ |
| Corrected | x | 1 | x | x |
| Prepended | 1 | 0 | x | x |
| Repeated | 0 | 0 | 1 | x |
| Continued | 0 | 0 | 0 | 1 |
| Grounded | 0 | 0 | 0 | 0 |

The states are described below. Examples of how these states may occur are given, and the action to be taken next is outlined.
ungrounded(corrected)—The buffer has corrected tokens (1_{B}) before the receiver focal point (fᵣ). This state will occur whenever tokens which have been offered to the caller are corrected by the giver and requires the next turn to wind-back and repeat previously offered tokens with an apology. See correctedChunk( ) for details.
ungrounded(prepended)—The buffer has initial tokens (1_{A}) but not corrected tokens (1_{B}) before the receiver focal point (fᵣ). This state should not usually occur unless the giver has explicitly inserted or prepended some tokens into the buffer and it is clear that the receiver has not made an error. (e.g. spontaneously giving an STD code at the end of a transfer sequence to be prepended on the start of the token buffer) and requires the next turn to wind-back and repeat previously offered tokens with an indication that this explicit change has been acknowledged. See correctedChunk( ) for details.
ungrounded(repeated)—The giver focal point (f_{g}) is before the receiver focal point (fᵣ) and the buffer contains no initial tokens (1_{A}) or corrected tokens (1_{B}) before the receiver focal point fᵣ. This state typically occurs when the offered tokens to date have been correct but for some reason the giver has echoed some of them and stopped short of the point that the last offer reached. For example givers sometimes exhibit disfluent re-starts where they begin from the start of the utterance again even if the transfer is going well. In this case there is no need to correct anything, but the receiver must re-synchronise to the giver's new focal point and signal that it has done so. This is done by repeating the givers previous input (with additional prior context if necessary) up to the point where the input ended. See repeatedChunk( ) for details.
ungrounded(continued)—The buffer contains no initial (1_{A}) or corrected tokens (1_{B}) before the receiver focal point (fᵣ) and the giver focal point (f_{g}) is the same or after the receiver focal point (fᵣ). The buffer also contains some unconfirmed tokens (i.e. 1_{A}, 1_{B}, F_{A}) on or after the receiver focal point—that is to say there are still some ungrounded tokens in the token buffer. This state will typically occur where a transfer is proceeding well and the giver has continued on from where the receiver left off. A straightforward echo of this continuation will usually suffice. See continuedChunk( ) for details.
grounded—The buffer is fully grounded. This occurs when none of the above conditions holds true—i.e. there are no unconfirmed tokens in the buffer (i.e. 1_{A}, 1_{B}, F_{A}) and the giver focal point (f_{g}) is not before the receiver focal point (fᵣ). In most normal use cases at this point the giver and receiver focal points will be equal to one another indicating that all tokens have been agreed and giver and receiver are in synchrony. The empty token buffer is a special case of a grounded token buffer.

If the buffer is fully grounded then the function match(tokenbuf) attempts, at step 1203 to match the sequence of agreed token values in the token buffer against an ordered list of pre-defined grammars (patterns of sequences), returning matched(grammar) if a particular grammar matches or nomatch if not.

For G grammars, each with a name (g_name) and a pattern (g_pattern):

for each g in (0..G−1) {

if (tokenbuf.value[1 .. M−1]) =˜ g_pattern[g]) { return

“matched(g_name[g])” }
}
return “nomatch”

where the operator ‘=˜’ returns TRUE if the token sequence matches the grammar, and FALSE if not.

A grammar definition is simply a representation of all possible token sequences which are valid for that grammar to be matched. At its simplest, each grammar definition could simply be a list of valid sequences. As is well known to those in the field, typically finite state grammars or context-free grammars are used as a compact way to enumerate valid paths. For example in the current embodiment of the invention regular expressions as used in the Perl programming language (these are finite state grammars), are used to define valid token sequences for each grammar.

For the telephone number transfer task shown in FIG. 11 the grammars are listed below. Summaries of the action to be taken in the event of this grammar matching are given
ok—a fully formed telephone number has been grounded. Complete the dialogue.
empty—This is a special state, but for convenience can be treated as a fully grounded buffer which matches an empty grammar. At the start of the dialogue the buffer will typically be empty. In response to an empty buffer a request is made for the whole code and number. Also during the dialogue, certain input conditions showing significant communication problems clear the buffer using clear(tokenbuf) and thus cause the dialogue to start again. Repeat prompting will subtly change wording as per standard dialogue practice in the field.
one missing—There is only one digit missing to make a full UK telephone number. This is a common mistake by UK callers. The dialogue ends with a failure condition.
too few—There are too few digits in the buffer to make up a full telephone number. The giver is asked for more.
no STD—There is a complete number body but no STD code. Prompt for the STD code. Invoke the function setInsert( ) to re-wind fₒ and fᵣ to the start of the buffer (i.e. make them one), and temporarily adjust the cost of insertion of any input token after the start state to be zero. Also the cost of inserting any input token after any token in the given state to be zero. See Table 7 and associated explanation for how this works. As a result of these temporary changes, the input it inserted at the head of the buffer. The default costs are restored prior to the next giver input once the token buffer contains new tokens again.

At step 1205 ( repair(tokenbuf)): this point is reached because the token buffer is fully grounded but none of the pre-defined grammars have matched. An attempt is made to repair the buffer such that it will match one of the pre-defined grammars. In the telephone number case, the repair is only considered successful if the ok grammar is matched after repair. See the description below under “Final Repair”.

Returning to FIG. 11, the function correctedChunk(tokenbuf) at Step 1114 is used when the token buffer is found to have the status ungrounded(corrected). The function decides the start (fₒ) and end (fᵣ) points in the buffer for the buffer token sequence, or ‘chunk’, to be offered back to the giver with a ‘sorry’ pre-pended to it, using the output( ) function.

The function is trying to establish the best point before the first ungrounded token (i.e. in state 1_{A} or 1_{B}) to start the output chunk. The end point of the next chunk to be output fᵣ is always set to the last giver focal point f_{g}. i.e. The receiver re-synchronises its focal point with the givers focal point. There are three sub-conditions which may be observed in the corrected chunk state. These define the choice of start point according which of the following ordered list of conditions is found to be true the first:
(a) First token in state 1B or 1A is found on or after fₒ. The first ungrounded token is before the start of the chunk that the giver has just heard. In this case keep the start point of the next offered chunk the same for the next offer. (i.e. fₒ remains the same).
(b) First token in state 1B or 1A is found before fₒ but on or after fᵢ. The first ungrounded token is before the chunk that the giver has just heard, but after the interpreted start of the last giver input. In this case adopt the start of the last giver input as the new receiver start point. (i.e. fₒ=fᵢ)
(c) First token in state 1B or 1A is found before fᵢ. The first ungrounded token exists prior to the interpreted start of the last giver input. This condition should not occur, but is included to keep the algorithm robust if changes to other parts of the algorithm render this condition possible. Adopt the token immediately after the last phrasal boundary before the first ungrounded token—or the start of the buffer if there are none.

This is represented by the following pseudo code.

/* Find the first ungrounded state and the phrasal boundary prior
to it */
boundary=0 /* Use start of buffer if no boundaries found */
for each k in (1 .. f_{g}−1) {

if ( tokenbuf.value[k]==”#” ) {boundary=k}
if ( tokenbuf.value[k]!=”#” && tokenbuf.state[k]=˜/1[AB]/) {

first=k;
continue; /* Jump out of the loop */

}

}
/* Apply the three conditions */

| if (fₒ <= first) {fₒ= fₒ} | /* i.e. start where started last |
|---|---|
| | time */ |

| else if (fᵢ <= first < fₒ) { fₒ = fᵢ } | /* i.e. start at the start |
|---|---|
| | of last input */ |

| else { fₒ = boundary+1 } | /* i.e. start just after first |
|---|---|
| | boundary before change */ |
| fᵣ=f_{g} | /* end at end of input */ |

where “=˜/1[AB]/” means matches “1A” or “1B”.

The adoption of previous start points either fₒ or fᵢ is intended to increase the likelihood that the giver will be able to know where in the token sequence the receiver echo starts. Where this is not possible the latest phrasal boundaries or the entire token buffer are used with the same intention in mind.

There are a number of different ways that this function could be written. For example if the last input was extremely long, then something earlier than the giver focal point could be adopted as the new receiver focal point (fᵣ). For example the first phrasal boundary after the previous giver focal point could be adopted, or even the first phrasal boundary after the last correction.

The function prependedChunk(tokenbuf) is used at Step 1116 when the token buffer is found to have the status ungrounded(prepended). The function decides the start (fₒ) and end (fᵣ) points in the buffer for the buffer token sequence, or ‘chunk’, to be offered back to the giver with a ‘ok’ pre-pended to it, using the output( ) function.

In the current instance of the invention the algorithm correctedChunk( ) is used to determine the pre-pended chunk. Another simple policy to adopt in this instance would be to rewind to the start of the buffer and repeat up to the end of the last giver input. i.e.
fᵢ=1
fᵣ=fᵢ.

The function repeatedChunk(tokenbuf) is used at Step 1118 when the token buffer is found to have the status ungrounded(repeated). The function decides the start (fₒ) and end (fᵣ) points in the buffer for the buffer token sequence, or ‘chunk’, to be offered back to the giver with a ‘yes’ pre-pended to it, using the output( ) function.

This grounding state is most likely to happen when a giver has repeated without correction part of the token sequence which has already been offered. As a result the lead given by the receiver is lost and the receiver must indicate that it has re-synchronised with the giver.

The function is trying to establish the best point before the giver start point to start the token sequence which will be re-offered. The end point of the next chunk to be output fᵣ is always taken to be the giver focal point f_{g}.

There are two sub-conditions which may be observed in the repeated chunk state. These define the choice of start point of the next output chunk to be output as follows:
a) fₒ<=fᵢ. That is to say the previous output chunk started on or before the supposed start point of the last input. In this case keep the start point of the next offered chunk the same for the next offer. (i.e. fₒ remains the same).
b) fₒ>fᵢ. That is to say the previous input wound-back before the previous chunk. In this case adopt the token immediately after the phrasal boundary before the giver start point (fᵢ). Otherwise, if there are no phrasal boundary before the first correction it re-starts from the start of the buffer.

Or in pseudo code:

| /* Find the last phrasal boundary before giver start point */ | |
|---|---|
| boundary=0 | /* Use start of buffer if no boundaries found */ |

for each k in (1 .. fᵢ−1) {

if ( tokenbuf.value[k]==“#”) { boundary = k }

| } | |
|---|---|
| /* Apply the two conditions */ | |
| if (fₒ <= fᵢ) { fₒ = fₒ } | /* i.e. start where started last |
| | time */ |
| else { fₒ = boundary+1 } | /* i.e. start just after first |
| | boundary before change */ |
| fᵣ=f_{g} | /* end at end of input */ |

The function continuedChunk(tokenbuf) is used at Step 1120 in the case that the status is ungrounded(continued). The function decides the start (fₒ) and end (fᵣ) points in the buffer for the token sequence in the buffer to be offered directly back to the giver with the output( ) function.

The next chunk is taken to start at the current receiver focal point (fᵣ) and end just after the first phrasal boundary (“#”) or the end of the buffer if there are no phrase boundaries.

fₒ=fᵣ
for each k (fₒ .. M−1) {

if (tokenbuf.value[k]==“#”) { fᵣ=k+1; return }
if (tokenbuf.state[k]==“S”) { fᵣ=k; return }

}
fᵣ=M /* Shouldn't happen */

After setting the pointer in Step 1114, 1116, 1118 or 1112, the system makes (except in the continued case) an appropriate announcement.

It then uses the output( ) function 1128 to play back to the giver the tokens contained between the modified receiver pointers. It also sets these token states to be F_{A} if they are not already F_{B}. That is to say is marks all of the offered items to the highest grounding state that is appropriate.

output( ) {

/* Mark each offered token to highest grounded state possible */
foreach k (fₒ .. fᵣ−1) {

if (tokenbuf.state[k]!=“F_{B}”) { tokenbuf.state[k]!=“F_{A}” }

}
/* Choose ending or continuing intonation foe end of chunk */
if (match(tokenbuf)==“ok”) { endIntonationOption=“ending” }
else { endIntonationOption=“continuing” }
/* Now play the chunk out */
chunk = tokenbuf.value[ fₒ.. fᵣ−1 ]
playBlock (chunk,endIntonationOption)

}

Where playBlock( ) is defined recursively to play out each phrase in the chunk at a time—phrases being defined by phrasal boundaries in the chunk.

playBlock (block,endIntonationOption) {

remainder = block
if (isEmpty(remainder) { return } /* recursive end point */
for each k (0 .. length(remainder)−1) {

if (tokenbuf.value[k]==“#” ∥ ( k == length(remainder)−1)) {

phrase=removeFromStart(k,remainder)
playChunk(phrase,endIntonationOption)

}

}

}

Note that the endIntonationOption is supported as in previous embodiments of the invention. This can be set to ‘ending’ or ‘continuing intonation’. As previously the ending intonation is set when the output function is playing out the last chunk in a buffer which matches the ‘ok’ grammar. The intention of this is to subtly signal that the receiver thinks that the end point of the transfer has been reached.

Following output, the function modifyCP(tokenbuf) 1129 (described below under “Final Repair” is invoked and the flow then proceeds to 1108.

In the event that the status is determined at 1104 to be repaired(ok), then at 1130 the function setToGiven(tokenbuf) is invoked. This function is used just after a repair has been successful on the token buffer. In order to force a re-grounding of the repaired buffer, all given (not state S) tokens in the buffer are set to state 1_{A} as if they had just been entered in one go by the giver. The giver focal point is set to the end of the sequence and the receiver focal point is set to the start of the buffer. More precisely:

For a token buffer of length M:

for each k in (1 .. M−1) {

if ( tokenbuf.state[k]!=“S”) {

tokenbuf.state[k]=“1A”
f_{g}=k+1

}

}
fᵣ=1
fₒ=1
fᵢ=1

Then an appropriate announcement is made at Step 1132. Logically the process should now proceed to re-evaluate the status of the token buffer at 1104. However for all non-empty ok match grammars the outcome of this test will always be ungrounded(continued). Thus for simplicity the process proceeds directly to step 1120. This starts at the start of the buffer again, and the process of progressive read-back and confirmation of the repaired token buffer is initiated afresh. In the case of the other various match conditions, an appropriate announcement is made (1134, 1136, 1138, 1140) and the process either terminates (1142, 1144)or proceeds to get(input) 1108.

Once the system receiver response has been decided, the givers response is recognised at step 1108 (get(input)). This recognised input is stored in a buffer similar to the token buffer where each input token has a value and a state. Initially these inputs will all have state ‘U’ and the process of getting the values for this input buffer has already been described previously.

Phrasal boundaries can be assigned by the recogniser recognising pauses long enough to be significant but too short to trigger timeout, though this could be extended to other prosodic features if so desired. For example the following papers describe how prosodic features other than pauses can be used to detect phrasal boundaries:

“Automatic Classification of Intonational Phrase Boundaries”, M. Q. Wang & J. Hirschberg, Computer Speech and Language, vol. 6 (1992), pp. 175-196. A review of the literature on phrasal boundary detection, prosodic and grammatical. The concept of phrasal boundaries is presented.

“Lexical Stress Modeling for Improved Speech Recognition of Spontaneous Telephone Speech in the JUPITER domain”, Chao Wang and Stephanie Seneff. Proceedings of Eurospeech 2001. Shows simple 2 and 4 class detection of stressed/unstressed vowels.

One other such cue to finding boundaries is by analysing grammars. This may be done using an algorithm such as addBoundaries( ) below.

addBoundaries(input,return) {

remainder=input;

if (isEmpty(remainder)) {/* recursive end point */

/* Add the final ungiven token,
and return. */

return.token=contactenate(return.token,“”)
return.state=concatenate(return.state,“S”)

}
/* Get the next chunk from the front of the remainder. */

start=removeChunkFromStart(remainder)

/* Now Append it to the new input with a phrasal boundary,
and keep original state
*/
/* Give boundary unknown state. */

return.token=concatenate(return.token, start.token, “#”)

return.state=concatenate(return.state, start.state, “U”)

/* Recursively call addBoundaries until empty. */

addBoundaries(remainder,return);

}

Using the same removeChunkFromStart( ) function as previously described or something similar.

The next section describes how the contents of the input buffer are categorised and then in some cases aligned with the token buffer in order to establish the best alignment of the two. Given the best alignment the states of the input buffer will then be assigned. For example an input token with state 1B will be a digit that is intended to correct a previously offered digit.

In the current embodiment, all input tokens have state ‘U’ denoting that the state is unknown. It is possible that, in the future, speech recognition will be able to detect the function of the input from the prosody prior to comparing it with the token buffer, for example noting that a particular digit was stressed following a leading‘No’. In this case the input buffer could be populated with partial state information prior to the alignment to make the alignment more accurate.

Process Input to Update Token Buffer

Following input of tokens at 1108, the input is now processed to update the state of the token buffer.

As can be seen in FIG. 11, the following cases are detected:

(a) Unclear digits. (e.g. “3 ? 4” with the middle digit being difficult to hear). A “sorry?” prompt is played at 1148 [Not the right number??] to prompt for a repetition of this block. ‘pardon?’ would be similarly effective.

(b) Unclear or ill-formed input. (e.g. “3 4 5 yes 3” or “no ? ? 5”). A prompt is played at 1148 and the token buffer is cleared at 1150. This will cause a re-prompt for the whole code and number. This is a catch-all state intended to match all conditions that other states fail to match.

(c) Pardon. A request for a repeat of what was just said. The buffer is simply left unchanged.

(d) Contradiction. A flat contradiction such as “no” is treated as garbled input and, after a “sorry” prompt at 1152 the token buffer is cleared at 1150.

(e) Contradiction and digit correction—possibly self-repaired digits (e.g. “no 3 4 5”). If the input itself contains a self-repair (e.g. “no 0 4 no 0 1 4 1”), it will first be repaired at 1110 using the localRepair algorithm described earlier. The fact that it is a clear contradiction will be noted, then the input will be optimally aligned against the current state of the token buffer and the buffer state updated using the intepretInput process 1112, to be described below.

(f) Plain digits with optional preceding “yes”—possibly self-repaired digits. Treated exactly as contradiction, except that it is uncertain whether this is a contradiction or continuation. This will be the dominant outcome for a dialogue that is proceeding without error.

(g) Completion signal (silence or “yes”). All offered, but unconfirmed tokens (F_{A} or 1_{B}) in the buffer before the receiver focal point are set to the confirmed state (F_{B}), and the given start point (fᵢ) and focal point (f_{g}) are set to be the same as the receiver focal point (fᵣ); the process proceeds to 1154

The clear(tokenbuf) function 1150 resets the whole buffer with empty values and puts every token apart from the initial start token to the ungiven state “S”.

For a token buffer of length M:

for each k in (1..M−1) {

tokenbuf.value[k]=“”
tokenbuf.state[k]=“S”

}

The function confirmToFocus(tokenbuf) at Step 1154 is called when the giver has said an isolated “yes” or remained silent following a set of tokens being offered. It sets all token states from the start of the offered region (fₒ) to the receiver focus to the ‘confirmed’ state F_{B}. Also, the giver start point fᵢ and focal point f_{g} are both set to the receiver focal point fᵣ. This is because it is assumed that the giver has adopted the receiver focal point when remaining silent or explicitly saying ‘yes’ after the focal point.

for each k in (fₒ .. fᵣ−1) {

tokenbuf.state[k]=”F_{B}“

}
fᵢ=fᵣ
f_{g}=fᵣ

It should be noted that this embodiment of the invention may be used for tasks other than digit entry. If the symbol ‘D’ in FIG. 11 is taken to mean ‘the grammar of legal tokens in this task’, then the conditions above would apply to any token transfer task. Appropriate completion criteria along with grammars would also have to be designed for a new task. It is however likely that the similar patterns for completion will be observed in many sequential token transfer tasks.

Interpreting the Input

The interpretInput(input,tokenbuffer) algorithm invoked at Step 1112 is designed to take an input buffer, and interpret what this input meant with respect to the current state of the token buffer. Once this interpretation is made, the token buffer is updated to reflect this.

The algorithm decides which interpretation of the input should be accepted by calculating the cost of replacing parts of the token buffer with this input. This is done using a dynamic programming model to align the new input against the token buffer, although other cost models could be used. The lowest cost replacement is accepted. Implicit in the approach described is the assumption that the input buffer is more correct than the token buffer. This is not a mandatory assumption, but in the absence of confidence information it is a reasonable one to make.

By way of example FIG. 13 shows how the input buffer and token buffer (FIG. 13(a) and 13(b) might appear during an interpretation for one possible alignment (k=3). FIG. 13(c) shows the new input interpretation given k=3 and FIG. 13(d) shows the new token buffer contents that would result, should this interpretation be selected.

This process proceeds as follows. First the input buffer is stripped of any grounding cues such as yes ‘Y’ and no ‘N’. The ‘N’ cue is remembered and used to exclude the interpretation of pure continuation later in the process. Recall that an additional token is added to the end of the input buffer with the state S (ungiven) and given an empty value. This is a special symbol which is used to permit the alignment of the end of the input to effectively complete at points before the end of the token buffer. This will be explained in more detail below.

An assumption is then made (but doesn't necessarily have to be made) that the input utterance is either a continuation from the current receiver focal point fᵣ, or a partial or complete repetition of previously offered or confirmed tokens. This means that the giver is assumed to never jump ahead of the receiver focal point—an assumption verified by experiment to be overwhelmingly true.

An attempt is then made to find the best alignment of the input against the token buffer. This is done by aligning the input against the buffer a number of times, each time considering a different possible start point in the token buffer, and finding the optimal alignment of the input up to or before the end of the token buffer. The search starts by assuming a start-point with a pure continuation from the current receiver focal point and then considers alternative start points stepping one token at a time backwards through the buffer right back to the start of the buffer. If the InsertInitial flag is TRUE (i.e. insertion at the head of the buffer is permitted by for example the setInsert( ) function) then the search aligns right the way back to the start symbol. Given a zero cost for insertion following this special symbol then the input will be inserted at this point. Otherwise for the normal case where InsertInitial flag is FALSE then it aligns back to the token following this. In this way the giver can be permitted to go right back to the start of the sequence at any time if they so desire.

Given a tokenbuf of length M and input of length N.

if (InsertInitial = TRUE) init=0
else init=1
For each k from (init .. fᵣ) {

(dₖ, f_{gk}, fᵣₖ, , fₒₖ, inputₖ) = DPAlign ( input
[0..N−1], tokenbuf[ fᵣ−k .. M−1]

)
}

So, fᵣ+1 n-tuples, one for each input interpretation associated with a value of k, will be generated where dₖ is interpreted as the cost of aligning input against the buffer from a starting point of k tokens back from the current receiver focal point fᵣ, the alignment yielding a new giver focal point f_{gk}, a corrected receiver focal point fᵣₖ, corrected receiver start-point fₒₖ and inputₖ represents the interpretation of the input. The function DP Align( ) is described later. Its function is to use dynamic programming techniques to find an optimal alignment of the input against a sub-portion of the token buffer, for the given value of k, but allowing for different possibilities of insertion, substitution or deletion.

Because insertions and deletions are possible, it is necessary to note the changes to the receiver focal point and receiver start point which will need to be applied should this input be accepted. The receiver focal point will change if tokens are inserted or deleted prior to the current receiver focal point. The receiver start point will only change if tokens are inserted or deleted prior to the current receiver start point. Any other stored indices which the algorithm relies on (for example see Correction Points as described later) will similarly need to be adjusted once a particular interpretation is adopted. Pointers to deleted elements in the buffer will assumed to point to the token following to the deletion as part of this adjustment.

In the current algorithm the token sequence in the input is always assumed to be correct by DPAlign. Given this assumption inputₖ will have the same values and length as input, but its states will be modified to reflect the interpretation placed on it by the alignment. Tokens will either be interpreted as confirmations F_{B}), corrections (1_{B}) or ungrounded information (1_{A}).

Selecting and Applying an Interpretation.

Given the set of possible input interpretations, the one with the lowest cost is selected. If the input utterance began with ‘no’, then the interpretation for k=0 is disallowed. If there are two interpretations with the same cost then the one with the highest value of k is selected, unless one of the interpretations is for k=0 in which case this is selected.

When the optimal interpretation has been selected then this interpretation is used to replace the region that it was matched against in the token buffer. Also the giver focus is set to the giver focus for interpretation k. More precisely, for the selected value of k,
tokenbuf[fᵣ-k . . . f_{g k}−1] is replaced by inputₖ[0 . . . N-2]
   and
fᵢ=fᵣ-k
f_{g}=f_{g k}

It is possible that insertions and deletions may have occurred also so the current receiver focal point, and the receiver start point are adjusted as a result of selecting this interpretation.
fᵣ=f_{r k}
fₒ=f_{o k}

Recall that the last token in inputₖ is a termination character which will be discarded and that tokenbuf may shrink or grow in length as a result of this operation.

The token buffer cost is then increased by the cost of the selected interpretation:
tokenbuf.cost+=dₖ,

The DPAlign( ) function used in interpretInput( ) uses a dynamic programming alignment algorithm. The basic principle of dynamic programming will be briefly explained with reference to FIG. 15.

A dynamic programming alignment algorithm essentially takes two sequences A, B of tokens and evaluates possible alignments of them to find the one representing the best match between them. More accurately, the algorithm established the optimal way to convert one sequence of tokens A into the other sequence of tokens B given a set of costs for deleting, inserting, and substituting tokens.

Any alignment may be thought of as involving inserting a null character or characters into one or both sequences to form two sequences A′, B′ of the same length (this length being of course greater than or equal to the larger of the two original lengths). If sequence A is 374 and sequence B is 3754 then a possible alignment would be
A′: 37−4
B′: 3754
   expressing the idea that one has to insert a null at the third position of A to bring them to the same length. Thus if the 374 has been played back for confirmation and the giver says “3754”, this alignment would correspond the interpretation that the giver is saying that there is a “5” missing. Alternatively
A′: 374−
B′: 3754
   would correspond to the interpretation that the giver is saying “it should be a five instead of a 4 and the next digit is a 4”.

Another example:
A′: 3−74−
B′: −3754

Once the sequences have been aligned in this way a measure of similarity between them (representing, in the current context, a cost of substituting one for the other) can be calculated. For example if the cost of aligning equivalent tokens is zero, a substitution of one for another is 1 and the cost of a deletion or insertion is 2 then in the first example the cost is simply that of inserting the ‘5’ into A—a cost of 2 units. In the second case the cost is that of two insertions, one deletion and one substitution, i.e. 7. Note that these values are for illustration only; also this is a symmetrical example for the purposes of illustration and that for present purposes the cost rules are more complex, as will be described shortly.

All possible alignments may be visualised by a graphical representation as in FIG. 16. A is shown along the vertical axis and B along the horizontal axis. The small squares represent nodes: the arrows represent all the possible paths through the nodes, from the top left top the bottom right. Traversing a horizontal arrow corresponds to an insertion from B into A—or copying the B-value for that column into B′,and a null into A′. Traversing a vertical arrow corresponds to deleting a token from A—or copying a null into B′ and copying the A-value for that row into A′; and traversing a diagonal arrow corresponds to a substitution—or copying both A and B into A′ and B′ respectively. The cost for any path entering a node is the cost associated with the preceding node plus the cost associated with the path itself. The cost associated with any node is the minimum of the costs associated with the three paths leading to that node. Costs for the example are shown on the diagram. The DP algorithm works through the nodes to find the costs whilst at the same time recording the paths that correspond to the cheapest route into a node. It then backtracks through the nodes from the bottom right and determines that corresponds to the minimum cost. The path shown in heavy lines is thus the optimal path. It corresponds to the first example given above.

A practical DP algorithm is described in our international patent application No. WO01/46945.

In the DP alignment a table of specific costs is used in order to evaluate the relative costs of various substitutions, deletions or insertions. Table 7 shows some example costs which could be used for a digit-only entry dialogue such as a telephone number entry. In the table some conventions are used. Unlike the algorithm described in our aforementioned international patent application, insertions and deletions are not symmetrical in this task. The sense of the terms insertion, deletion and substitution (ins, sub, del) are used to refer to what changes would have to be made to the token buffer in order to transform it into the input buffer. The term ‘Eq’ is also used to represent a special case of substitution—the substitution of a token with another token of the same value. FIG. 14 shows the sense of the operations graphically with respect to the DP alignment cost matrix.

Also, when looking up costs in the table during the DP alignment additional state information from the input buffer and the token buffer is used to decide which specific cost to use. The state of the input will usually be ‘unknown’ U as current recognition systems do not yield the necessary additional prosodic information to decide the exact state of a particular input token. The role of state of the token buffer has already been described. The final state of the input token if it were to be used to alter the token buffer is also given in the table.

Unlike an ordinary DP match however, contextual information is also used to select between different specific costs for deletion and insertion. FIG. 14 shows which tokens are taken as the context during the DP cost calculation. The effect of these contexts may be interpreted as follows. In the case of the deletion of a token in the buffer, it is the state and value of the input token that aligns with the token that is just before the deletion, and the state and value of the buffer token being deleted which are used to decide the context. In this case of insertion of an input token into the token buffer, it is the state and value of the input token being inserted and the state and value of the buffer token after which it will be inserted which are used to decide the context. For substitution, the context of the two tokens under consideration for the substitution are used as the context.

The dynamic programming algorithm aligns the input fully with the whole of the portion of the token buffer starting at index (fᵣ-k ) to the end of the token buffer. However the special end-of-input character is used in a special way to permits such alignments to result in an interpretation where the end of the input (excluding the special character) to align with a point before the end of the token buffer. This is explained below in more detail.

Table 7 shows an example set of costs for the digit token example. By way of example, referring to Table 7, the cost of substituting a digit in the token buffer in the state F_{B} with an input token with a different value in the U state can be seen to be 1.5. The state of this matching token in this input interpretation will become 1_{B}—i.e. a corrected input.

TABLE 7
Example alignment costs for digit tokens with unknown input token function.

| | | | Token | Token | | | |
|---|---|---|---|---|---|---|---|
| | Input | Input | Buffer | Buffer | End | | |
| Type | token | state | token | state | state | Cost | Action on token buffer |
| Eq | [0-9] | U | [0−9] | 1_{A}\|1_{B} | F_{B} | 0.0 | Substitute given token with same |
| | | | | | | | input |
| Eq | [0-9] | U | [0-9] | F_{A} | F_{B} | 0.01 | Substitute offered token with |
| | | | | | | | same input |
| Eq | [0-9] | U | [0-9] | F_{B} | F_{B} | 0.05 | Substitute confirmed token with |
| | | | | | | | same input |
| Sub | [0-9] | U | “” | S | 1_{A} | 0.0 | Substitute ungiven token with |
| | | | | | | | different input |
| Sub | [0-9] | U | [0-9] | 1_{A}\|1_{B} | 1_{A} | 1.0 | Substitute given token with |
| | | | | | | | different input |
| Sub | [0-9] | U | [0-9] | F_{A} | 1_{B} | 1.0 | Substitute offered token with |
| | | | | | | | different input |
| Sub | [0-9] | U | [0-9] | F_{B} | 1_{B} | 1.5 | Substitution confirmed token with |
| | | | | | | | different input |
| Ins | [0-9] | U | [0-9] | 1_{A}\|1_{B} | 1_{A} | 1.5 | Insert input after given token |
| Ins | [0-9] | U | [0-9] | F_{A} | 1_{B} | 2.0 | Insert input after offered token |
| Ins | [0-9] | U | [0-9] | F_{B} | 1_{B} | 2.5 | Insert input after confirmed token |
| Ins | [0-9] | U | “” | S | | 999 | Insert input after ungiven token - |
| | | | | | | | disallowed. |
| Del | [0-9] | U | “” | S | | 999 | Delete ungiven token after input |
| | | | | | | | token - disallowed. |
| Del | [0-9] | U | [0-9] | 1_{A}\|1_{B} | | 1.5 | Delete given token after input |
| | | | | | | | token. |
| Del | [0-9] | U | [0-9] | F_{A} | | 2.0 | Delete offered token after input |
| | | | | | | | token. |
| Del | [0-9] | U | [0-9] | F_{B} | | 3.0 | Delete confirmed token after input |
| | | | | | | | token. |

Special Rules for Input End-Marker:

| | | | | | | | |
|---|---|---|---|---|---|---|---|
| Del | “” | S | * | * | | 999 | Delete any token in any state after |
| | | | | | | | terminal input token - disallowed. |
| Eq | “” | S | “” | S | | 999 | Substitute ungiven token with |
| | | | | | | | terminal input token disallowed. |
| Sub | “” | S | * | * | | 999 | Substituting any token in any state |
| | | | | | | | with terminal input token |
| | | | | | | | disallowed. |
| Ins | “” | S | * | * | S | 0.0 | Insertion of terminal input token, |
| | | | | | | | before any token in any state, has |
| | | | | | | | zero cost. (Marks the end of the |
| | | | | | | | input) |
| Del | “” | S | [0-9] | 1_{A}\|1_{B}\|S | | 0.0 | Delete ungrounded token after |
| | | | | | | | terminal input token at zero cost. |
| Del | “” | S | [0-9] | F_{A} | | 0.4 | Delete offered token after |
| | | | | | | | terminal input token |
| Del | “” | S | [0-9] | F_{B} | | 0.8 | Delete confirmed token after |
| | | | | | | | terminal input token |

Special Rules if ‘InsertInitial’ flag is set.

| | | | | | | | |
|---|---|---|---|---|---|---|---|
| Sub | start | F_{B} | * | * | | 999 | Substitution of start symbol |
| | | | | | | | disallowed. |
| Ins | start | F_{B} | * | * | | 0 | Insertion of input token after start |
| | | | | | | | symbol free. |
| Del | start | F_{B} | * | * | | 999 | Deletion of start symbol |
| | | | | | | | disallowed. |
| Ins | [0-9] | U | [0-9] | 1_{A}\|1_{B} | 1_{A} | 0 | Insert input after given token |

Rules for inputs with known states.

| | | | | | | | |
|---|---|---|---|---|---|---|---|
| Sub | [0-9] | 1_{B} | [0-9] | * | 1_{B} | 0.0 | Substitute any token with |
| | | | | | | | correcting input - free |
| Ins | [0-9] | 1_{B} | [0-9] | * | 1_{B} | 1.5 | Insert correcting input after any |
| | | | | | | | token - free |
| Del | [0-9] | 1_{B} | [0-9] | 1_{A}\|1_{B} | | 1.5 | Delete given token after |
| | | | | | | | correcting input - unchanged |
| Del | [0-9] | 1_{B} | [0-9] | F_{A} | | 2.0 | Delete offered token after |
| | | | | | | | correcting input - unchanged |
| Del | [0-9] | 1_{B} | [0-9] | F_{B} | | 3.0 | Delete confirmed token after |
| | | | | | | | correcting input - unchanged |

Some features of the table can be drawn out to illustrate its operation. It can be seen that the cost of substitution of tokens with the same value in the alignment starts at zero and increases slightly as the state of the substituted token becomes more grounded. This creates an in-built preference for small values of k, whilst permitting givers to go right back to the start of an input, even if it is grounded, if they so desire.

Secondly, it can be seen that there is no cost at all for substituting ungiven values. This simply means that freshly given tokens get appended to the end of the buffer at no cost if there are no previously given token to be substituted. The cost of substituting a given or offered token with a different one is unity (1.0) rising to a higher value if the token being substituted is fully confirmed. This means that confirmed items can still be corrected, as it has been observed that givers may mistakenly confirm erroneous inputs, but interpretations for correcting tokens in lower grounding states are preferred.

Insertion of input tokens into the buffer (i.e. growing the buffer in size by putting extra tokens into the middle of it) are strongly penalised but are possible. This reflects that observed fact that, for grammar constrained number input, insertion errors are less likely that substitution errors in a speech recogniser. Other tasks or grammar types may have different characteristics. At this high cost, insertion will only really tend to happen in long buffers that have not yet been offered or are not fully grounded. It has been observed that people can omit a single token when giving information for the first time, and may not notice if the information is entered in a long sequence of tokens in the first place. An exception to this occurs when the InsertInitial flag is set following a setInsert( ) operation. This is to permit digits to be inserted at the head of the buffer temporarily.

Recall that DP alignment fully aligns both the input buffer and the potion of the token buffer selected by variable k. This is not always desirable in this case. For this reason the cost structure is set up such that when the final meaningful token in the input has been aligned in the DP search, the final dummy input token in the ‘S’ state will insert optimally immediately following it. This token is then permitted to delete remaining tokens in the token buffer up to the end point—freely if the tokens are ungrounded or at a cost if not. This mechanism allows the end of the input to align with tokens other than the end of the tokens in the token buffer if this gives an optimal fit. This is appropriate especially if the remaining tokens in the buffer are still in state “1_{A}”—comprising the ‘remainder’ seen in previous embodiments of the invention. When interpreting this alignment the algorithm defines the end align point of the input to be where the ‘S’ state was inserted in the optimal trace and retains all of the deleted token after this point in the token buffer.

Phrasal Boundaries

It was noted previously that it is also possible to accommodate phrasal boundaries in the buffer, and also in the input. Putting phrasal boundaries in the buffer is useful for two primary reasons. Firstly, it permits the system use adopt the chunking strategy used by the giver (mid utterance phrasal boundaries if these can be detected by the input device) when reading back the number to the receiver. This can be seen in the operation of continuedChunk( ) which uses the phrasal boundaries to determine whether the whole or part of the ungrounded material left in the buffer should be read out for confirmation next.

Secondly, the boundaries are used to bias the alignment of inputs to the buffer. This supports the observation that givers and receivers co-operate together to use common phrasal boundaries to remain in synchronisation. However is also support divergence from these patterns if the receiver or giver should choose to do so. Table 8 shows a set of costs which will support this functionality. The principles underlying this table are that a phrasal boundary should never delete a token, and that in general phrasal boundaries should align between the token buffer and the input, but where they don't, both phrasal boundaries are retained. This has the potential to proliferate phrasal boundaries in certain circumstances, namely where the giver and follower do not accept the same phrasal boundaries. In these circumstances the algorithm will tend to offer smaller chunks of output tokens.

TABLE 8
Extending alignment costs to take into account phrasal
boundaries. Unaffected contexts are shown in grey.

| | | | Token | Token | | | |
|---|---|---|---|---|---|---|---|
| | Input | Input | Buffer | Buffer | End | | |
| Type | token | state | token | state | state | Cost | Description |
| Sub | # | U | [0-9] | * | | 999 | Substitution of token with # disallowed |
| Sub | [0-9] | U | # | * | | 999 | Substitution of # with token disallowed |
| Ins | # | U | # | * | | 999 | Insertion of input # before # |
| | | | | | | | disallowed. |
| Del | # | U | # | * | | 999 | Deletion of any # after input # - |
| | | | | | | | disallowed. |
| Ins | # | U | “” | S | | 999 | Insertion of # after ungiven token - |
| | | | | | | | disallowed. |
| Del | # | U | “” | S | | 999 | Deletion of ungiven token after # - |
| | | | | | | | disallowed. |
| Eq | # | U | # | * | F_{B} | 0.0 | Align with another # - free. |
| Sub | # | U | “” | S | 1_{A} | 0.0 | Substitution of ungiven token with # - |
| | | | | | | | free. |
| Ins | # | U | [0-9] | 1_{A}\|1_{B} | U | 0.1 | Insertion of input # after given token |
| Ins | # | U | [0-9] | F_{A} | 1_{B} | 0.1 | Insertion of input # after offered token |
| Ins | # | U | [0-9] | F_{B} | 1_{B} | 0.2 | Insertion of # after confirmed token |
| Ins | [0-9] | U | # | 1_{A}\|1_{B} | U | 1.5 | Insertion of digit after given # (same as |
| | | | | | | | token) |
| Ins | [0-9] | U | # | F_{A} | 1_{B} | 2.0 | Insertion of digit after offered # (same |
| | | | | | | | as token) |
| Ins | [0-9] | U | # | F_{B} | 1_{B} | 2.5 | Insertion of digit after confirmed # |
| | | | | | | | (same as token) |
| Del | # | U | [0-9] | 1_{A}\|1_{B} | | 1.5 | Deletion of given token after input # |
| | | | | | | | (same as token) |
| Del | # | U | [0-9] | F_{A} | | 2.0 | Deletion of offered token after input # |
| | | | | | | | (same as token) |
| Del | # | U | [0-9] | F_{B} | | 3.0 | Deletion of confirmed token after input |
| | | | | | | | # (same as token) |
| Del | [0-9] | | # | 1_{A}\|1_{B} | | 0.1 | Deletion of given # after input token |
| Del | [0-9] | | # | F_{A} | | 0.1 | Deletion of offered # after input tokens |
| Del | [0-9] | | # | F_{B} | | 0.2 | Deletion of confirmed # after input |
| | | | | | | | token |
| Del | “” | S | # | 1_{A}\|1_{B}\|S | | 0.0 | Delete ungrounded token after terminal |
| | | | | | | | input token at zero cost. (same as |
| | | | | | | | token) |
| Del | “” | S | # | F_{A} | | 0.4 | Delete offered token after terminal |
| | | | | | | | input token (same as token) |
| Del | “” | S | # | F_{B} | | 0.8 | Delete confirmed token after terminal |
| | | | | | | | input token (same as token) |

The costs are also set-up under the principle that the phrasal structure of grounded material is slightly more costly to alter than those in ungrounded material. This if the giver chooses an alternative phrasal structure when repeating a portion of the token sequence which has not yet been grounded then this new phrasal structure will be accepted at low cost. Having said this, in general the cost contribution of changing phrasal boundaries is generally kept low to ensure that the phrasal boundaries are less important than the tokens for accurate alignment.

As an alternative to the use of special tokens to signal the phrasal boundaries, one could instead—with, of course, corresponding modification to the DP algorithm, store these boundaries as additional state information with an additional storage location for each token being provided for this purpose, as illustrated in FIG. 15.

Local Repair

As described in the previous embodiments local repair (1110) occurs if there are any spontaneous repairs within a single input block (e.g. “3 4 5 no 4 6”). The input_block is repaired prior to being further processed. In this embodiment local repair is also performed using the same interpretInput function which is used to align other material which has a possible correcting function. This happens as follows:

localRepair(input) {

if (input.value =˜ /N/) {

/* Split the input buffer left and right buffers around
the No */
correction=FALSE
left=emptyBuffer( )
right=emptyBuffer( )
foreach k (0..length(input−1) {

if (input.value[k]==“N”) {correction=TRUE; }
if (! correction) { left = Concatenate(left,input[k]) }
else { right=Concatenate(right,input[k]) }

}
/* interpretInput to find lowest cost repair of left
part with the right */
/* NB k=0 disallowed as an interpretation. */
/* Left will be repaired in the process */
interpretInput(right,left)
/* Now set the left token up with unknown state again
as it is to act as an

input */

left.state=“U”
left.cost=0
input=left;

}

}

Final Repair and Correction Points.

Correction Points

Final repair (1205, FIG. 10) in the fourth embodiment of the invention is similar to that shown in previous embodiments but is simplified. It also uses the same cost based dynamic programming alignment mechanism as has already been described. In this simplified usage, Correction Units (CU's) are non-overlapping regions of the token buffer between Correction Points (CP's). Recall that previously CU's could overlap. CP's are simply pointers into the token buffer to a point where a pure continuation was decided upon following an interpretation of the input. Recall that, as in previous embodiments, at these points the giver cannot tell whether their input has been interpreted as a continuation or a correction due to the simple echo strategy employed.

Correction Points are noted as an ordered list of indices into the token buffer. They are considered to be part of the token buffer structure. Each index in the list refers to a single CP. Only one correction point can exist for a given index in the buffer. Correction points are ordered such that CP's higher in the list always occur after CP's lower in the list. Correction points may removed from the list as well as created. Note that when the token buffer is updated following an input, as with the basic token buffer pointers, the indices in the CP list must also be altered to compensate for any lengthening or shortening of the token buffer due to insertions or deletions.

CP's are created by the function addCP(tokenbuffer) 1113 following the function interpretInput( ) 1112. If k=0, i.e. a pure continuation, this function inserts a single CP with index fₒ. into the CP list unless a CP already exists with this index. If k>0 then no CP is inserted. By definition, there will always be a CP at index 1. This is a special CP retained for algorithmic convenience. It cannot have a repairing function.

CP's are destroyed if any chunk which is to be played out by output( ) crosses a CP boundary. The function modifyCP(tokenbuffer) 1129 checks for this condition. In this function CP's with an index between (fₒ+1) and (fᵣ−1) are deleted. The rationale behind this action is that the giver will hear a sequence of tokens before they hear the token at the CP. In this way, a point of ambiguity which previously existed is not ambiguous to the giver any more. Thus it is removed.

For the special case when tokens are insertion start of the buffer—this should be treated as a pure continuation for the purposes of the CP algorithm. This will occur for example following the temporary adjustment of costs as a result of the setInsert( ) function. A new CP at index 1 should be set. The CP that was at index one is retained at its new right-shifted position. The CP is retained because the current cost structure associated setInsert( ) always inserts at zero cost—thus if the insertion partly contains a continuation into the shifted material this will not be captured at that point. However if we treat the sequence following the insertion as if it were a possible ambiguous correction of the preceding tokens then this wrong assumption can be repaired in the final repair stage.

There is a Correction Unit (CU) corresponding to each CP. This CU stretches from the index of its corresponding CP to the index before the next CP—or to the end of the buffer if there is no following CP.

Final Repair

Following a failure to match any grammar in a grounded token buffer. Final repair is attempted at 1125 by the repair( ) function. This takes a token buffer with its correction points, and attempts to find a new interpretation which matches one of the grammars (‘ok’ being the preferred match) with the lowest possible additional cost.

The final repair process is a stack based operation. Initially the stack is populated, in any order, with a number of copies of the token buffer. In these initial copies different permutations of the CP's are retained or discarded to represent all possible permutations of the existing CP's—excluding the case where there are no CP's (This has already failed the match test and is therefore not worth exploring). In the original buffer CP's represented possible correction points. In these new hypotheses, the presence of a CP indicates that for this hypothesis there is definitely a correction at that point. The initial CP is treated as a special correction point and is always retained. Thus, if the token buffer contains NCP correction points then there will be (2^{N}CP−1−1) copies of the buffer on the stack. Previous embodiments of the invention only allowed the equivalent of one correction per buffer. This embodiment allows multiple corrections if they have a low cumulative cost. If the previous behaviour is to be emulated, then this step could simply create NCP−2 hypotheses instead where each hypothesis contains only one correction point plus the initial correction point.

An input and output stack are used in the repair process. Initially the input stack is as described above and the output stack is empty. When the repair process has found an optimal repair for a given CP hypothesis it puts this repaired hypothesis onto the output stack. The repair process itself can generate additional hypotheses as we will see below. When the input stack is empty, then the iterate part of the repair process is complete. All that remains is to look for a hypothesis in the output stack with sufficiently low repair cost which matches one of the completion-state grammars. The ‘ok’ grammar is the only one considered currently—but others could be if desired (for example the ‘no STD’ grammar.)

The algorithm pops hypotheses off an input stack until the stack is empty. The order in which repair occurs at the CP's in this hypothesis is important. There are N factorial (N!) evaluation orders for a hypothesis with N active CP points. The algorithm evaluates all of these possibilities by stepping through the active CP's in the current hypothesis and selecting each CP's as the start point. An optimal repair is made at this point by aligning the CU after the CP with the CU before the CP. The same interpretInput( ) algorithm is used that was used in the live dialogue based repair. In this way the finalRepair algorithm could be seen to be evaluating the options which were second best when interpretation of k=0 were selected in the live dialogue.

By repairing at the site of this CP, it is eliminated as a result and the resulting new hypothesis now contains N-1 CP's in it. If there are remaining active CP sites then this new hypothesis is placed back on the stack for evaluation at a later date. By following this procedure for all possible CP start point then a hypothesis with N active CP's will generate N new hypotheses on the stack with (N-1) active CP's in place of the original hypothesis. By evaluating the stack until it is empty this will create the necessary N factorial (N!) evaluations to explore all possible start points.

For larger numbers of CP's this could create a combinatorial explosion. As an efficiency measure, a cost threshold is set—above which repairs are not considered. Thus if any repair takes the hypothesis above the threshold then that particular chain of evaluations is abandoned.

The pseudo code for this process is as follows:

repair (tokenbuffer)

instack = permute(tokenbuffer) /* permute up hypotheses */

repeat {

| pop (current, instack) | |
|---|---|
| CP=current.CPIist | /* CP is an array of indices */ |

| | |
|---|---|
| CU=makeCU's(CP) | /* Make array of CU's from the CP's */ |

| | |
|---|---|
| numCU=length(CU) | /* number of CU's in the hypothesis */ |

| | |
|---|---|
| foreach n (1 .. numCU−1) { | /* loop CU's in order (excl 1^{st} CP). */ |

| /*copy parts of the buffer into mini − buffers */ | |
|---|---|
| /* each copy has zero cost initially */ | |
| preCU = CU[0..n−2] | /* leading CU's */ |
| leftCU = CU[n−1] | /* CU to be repaired */ |
| rightCU = CU[n] | /* CU doing the repairing */ |
| postCU = CU[n+1] | /* trailing CU's */ |

/* set left part as if it was a confirmation. */
/* set right part as per an input with leading ”No” */
setAllStates (leftCU,”FA”)
insertLeadingNo(rightCU)
setAllStates (rightCU,”U”)
/* interpretInput to find lowest cost repair the left CU with the right CU */
/* NB k=0 disallowed as an interpretation. */
/* The right CU will incorporate the left CU in the process */
/* The right CU will also have the cost of the repair as its cost */
interpretInput(rightCU,leftCU)
/*now concatenate this repaired portion back into the hypothesis*/
/*NB one CP will have been erased in the process */
/*Increase the cost of this hypothesis by repair cost */
new=concatenate(preCU,leftCU,postCU)
new.score=current.score+rightCU.score
/* If cost getting too great abandon this hypothesis */
/* Else still has CP's? pop this new hypothesis back onto stack for processing
*/
/* if not, then pop onto output as possible completed hypothesis */
if (new.score < threshold) {

if (length(new.CPlist) > 2) { push (new −> instack) }
else { push (new−>outstack) }

}

| | |
|---|---|
| } until (empty(instack)) | /* stack is empty completion criteria */ |

/* Find lowest scoring hypotheses which matches ok grammar */
lowscore=999999;
best=emptyBuffer( );
repeat {

hypothesis=pop(outstack)

if ((match(hypothesis)=”ok”) && (hypothesis.score<lowscore)) {

best=hypothesis
lowscore=hypothesis.score

}

} until (empty(outstack))
/* If any matched return the lowest scoring one, or nomatch */
if (best.isEmpty( )) return (“nomatch”)
else {

tokenbuffer=best
return (“repaired(ok)”)

}

}

Appendices

Appendix A. Chunk Decision and Play-Back Algorithms

The following pseudo code detects and removes and returns an UK STD code at the start of a block. NB STD code patterns can change fairly frequently in the UK due to strong regulatory involvement.

removeStdFromStart(remainder) {

std=“”
if (remainder=˜ “(\hat{ }020) || (\hat{ }023) || (\hat{ }024) || (\hat{ }028)

|| (\hat{ }029)”) #3 digit STD's
{ std=removeFromStart(3,remainder); return std}

else if (remainder=˜“(\hat{ }01[0-9]1) || (\hat{ }011[0-9]) ||

(\hat{ }0[3-9][0-9][0-9])”)

| | |
|---|---|
| { std=removeFromStart(4,remainder); return std} | #4 digit STD's |

else if (remainder=˜“\hat{ }0[1-9][0-9][0-9][0-9]”)

| | |
|---|---|
| { std=removeFromStart(5,remainder); return std} | #5 digit STD's |

else return std;

}

The following pseudo code then uses this function to take a block of digits and identify the next chunk in a block to be read out.

removeChunkFromStart(remainder,isStd) {

# Remove the next chunk from the remainder, set isStd
flag if chunk is an Std code.

isStd=FALSE

N=length(buffer)
if (N==0) { return }
if (std=removeStdFromStart(remainder)) { isStd=TRUE;
return Std }
if (1<=N<=4) { chunk=removeFromStart(N,remainder);
return chunk }
if (N==5) { chunk=removeFromStart(2,remainder);
return chunk }
if (6<=N<=7) { chunk=removeFromStart(3,remainder);
return chunk }
if (N==8) { chunk=removeFromStart(4,remainder);
return chunk }
if (N>=9) { chunk=removeFromStart(3,remainder);
return chunk }

}

Alternatively, when deciding on chunk boundaries within a buffer, regular expressions may be used to match certain patterns in the buffer which are known to contain common boundaries when they are read-out. These regular expressions could also contain right-context for the boundaries—i.e. the regular expression may be split into two parts as below:

For example, the following two UK STD codes:
01159 Nottingham, Notts
0115 Arnold, Notts

The regular expression containing:
std=(0115)([0-8])∥(01159) . . .
allows these two to be distinguished. By using the part of the buffer which matched the first bracketed expression to decide the chunk boundary after an STD code, for example, right-context can be taken into account when deciding on digit chunk boundaries.

The following pseudo code describes how to use removeChunkFromStart to realise chunked number read-out of a input digit sequence (whole or part of a telephone number). The ‘endIntonationOption’ permits the giver to define whether the intonation of the very final chunk will be “ending” or “continuing”. For example if the dialogue is sure that the end of the input block is the end of a UK telephone number it may choose to use ending intonation to signal this. Otherwise continuing intonation will encourage the giver to keep saying new chunks.

playBlock(block,endIntonationOption) {

remainder=block;
if (isEmpty(remainder)) { return; } # recursive end point
chunk=removeChunkFromStart(remainder,isStd)
#Now play it with ending intonation option if no digits after
this, else play with

continuing intonation.

if (isStd) {pause=20} else {pause=10}
if (isEmpty(remainder) { playChunk(chunk,endIntonationOption); }
else {playChunk(chunk,“continuing”); playPause(pause) }

playBlock(remainder,endIntonationOption);
}

The following function plays a chunk of digits out imposing an appropriate intonation on the chunk to make it sound natural. If endInton=“ending” then the intonation of the final digit of the chunk will signal that there are no more chunks to follow (e.g. signal that the dialogue believes that the last chunk in the telephone number has been received). If endInto=“continuing” then the final digit will have intonation which indicates that further digits are to follow in a subsequent chunk.

The chunk is realised as a concatenation of pre-recorded files spoken by a professional speaker in context. These files were recorded by asking the speaker, for each digit oh-9 to say digit chunks of the same repeated digit with ending or continuing intonation. The artist is instructed to avoid co-articulation between the digits. A recording is made for each digit for each chunk size (from 1 digit chunks through 4 digit chunks) for each type of ending intonation—hence 80 chunks are recorded. These chunks are then edited into separate digits and a naming scheme used to identify them. Any arbitrary chunk of size 1-4 may then be synthesised with high quality from these digits with either continuing or ending intonation at their end point.

An couple of examples are given below:

| | |
|---|---|
| continuing_4_2_3.wav | Play the digit “2” selected from the third digit |
| | place of a four digit chunk that was recorded |
| | with continuing intonation |
| ending_3_7_1 | Play the digit “7” selected from the first place |
| | of a three digit chunk that was recorded with |
| | ending intonation. |

The pseudo code to realise chunks using this scheme is given below:

playChunk(chunk,endInton) {

| L=length(chunk); | |
|---|---|
| for (i=1; i<=L; i++) { | #NB. index starts at one. |

filename=endInton+“_”+L+“_”+chunk[i]+“_”+i;
play filename;

}

}

Appendix B. FinalRepair( ) Algorithm

Operators
LEN(string) returns an integer, being the length of string
SUBST(string1, string2) returns a 1 if the two strings are identical except for one digit
SINS(string1, string2) returns a 1 if string2 is identical to string 1 except that the latter has a digit missing.
LEFT, RIGHT, CONCATENATE are obvious.

Problem
Wanted length=W

We have a number consisting of N blocks. Each block is represented by an index—BI(n) (n=0 . . . N-1) which indicates the start location in the telno buffer at which block n starts.

The number of digits in block B(n) is BL(n). Therefore Block B(n) is defined to be the region in the telno buffer as follows:
B(n)=telno[BI(n) . . . BI(n)+BL(n)-1]

The total length T of the number is SIGMA(BL(n)) for n=0 . . . N-1
The number exceeds the wanted length by E: i.e. T=W+E

A Correction Unit may consist of a single block or span all or part of several blocks

Correction Unit C(n) is the unit beginning with block n and is L(n) tokens in length. The definition of CU(n) is therefore:
C(n)=telno[BI(n) . . . BI(n) . . . +L(n)-1]

If a particular block n does not have a Correction Unit associated with it then L(n)=0 signifying that there is no Correction unit corresponding to block n.

Case 1: Correction unit n differs from block n-1 by one digit, whether by substitution, insertion or deletion. Action=delete block n-1

Example

| | block n-1 | CU n |
|---|---|---|
| substitution | 12345 | 12445 |
| insertion | 12345 | 123475 |
| deletion | 12345 | 1345 |

Code

COUNT=0
FOR n = 1 TO N−1

IF L(n)=0 GOTO notcu
IF (SUBST(C(n),B(n−1))=1 OR SINS((C(n),B(n−1))=1 OR
SINS((B(n−1), C(n))) = 1
THEN

COUNT = COUNT+1
IF (COUNT > 1) THEN

RETURN FAIL

END IF
nn=n

END IF

notcu:
NEXT N
IF COUNT = 1 THEN

DELETE B(nn−1)
RETURN SUCCESS

END IF
RETURN TRY_NEXT_STAGE

Case 2: Correction unit n is the same as the last L(n) digits of block n-1, with one substitution. Action: Replace last L(n) digits of block n-1 with CU n and delete CU n

Example

| | block n-1 | CU n |
|---|---|---|
| (if E = 5) | 12345678 | 45668 |

Code:

COUNT=0
FOR n = 1 TO N−1

IF L(n)=0 GOTO notcu
IF (SUBST(C(n),RIGHT(B(n−1),L(n))=1) THEN

COUNT = COUNT+1
IF (COUNT > 1) THEN

RETURN FAIL

END IF
nn=n

END IF

notcu:
NEXT N
IF COUNT = 1 THEN

B(nn−1) = CONCATENATE
( LEFT(B(nn−1),(BL(nn−1)−L(nn))) , C(n) )
DELETE C(n)
RETURN SUCCESS

END IF
RETURN TRY_NEXT_STAGE

Case 3: Concatenation of blocks n-k to n-1 (k>=1) is the same as the first E digits of CU n (where E<=L(n)). Action: delete blocks n-k to n-1.

| | Example | | |
|---|---|---|---|
| | block n-2 | block n-1 | CU n |
| (if E = 6, k = 2) | 123 | 456 | 123456789 |

Code

COUNT=0
FOR n=1 TO N−1

IF L(n)=0 NEXT n
FOR k = 1 to n−1

e= SUM(B(n−k) ... B(n−1)
IF e>L(n) NEXT k
IF CONCATENATE(B(n−k) ... B(n−1))=LEFT (C(n),e) THEN

COUNT = COUNT+1
IF (COUNT > 1) THEN

RETURN FAIL

END IF
nn=n
kk=k

END IF

NEXT k

NEXT n
IF COUNT = 1 THEN

FOR k = (nn−kk) to (nn−1)
DELETE B(k)
RETURN SUCCESS

END IF
RETURN TRY_NEXT_STAGE

Case 4: Concatenation of blocks n-k to n-1 (k>=1) is the same as CU n with one substitution. Action: delete blocks n-k to n-1

| | Example | | |
|---|---|---|---|
| | Block n-2 | block n-1 | CU n |
| (if E = 6, k = 2) | 123 | 456 | 122456 |

Code

COUNT=0
FOR n=1 TO N−1

IF L(n)=0 NEXT n
FOR k = 1 to n−1

IF SUBST( CONCATENATE(B(n−k) ... B(n−1)) ,
C(n) )=1 THEN

COUNT = COUNT+1
IF (COUNT > 1) THEN

RETURN FAIL

END IF
nn=n
kk=k

END IF

NEXT k

NEXT n
IF COUNT = 1 THEN

FOR k = (nn−kk) to (nn−1)
DELETE B(k)
RETURN SUCCESS

END IF
RETURN TRY_NEXT_STAGE

Case 5: Concatenation of blocks n-k to n-1 (k>=1) is the same as the first E digits of CU n with one substitution. Action: delete blocks n-k to n-1

| | Example | | |
|---|---|---|---|
| | block n-2 | block n-1 | CU n |
| (if E = 6, k = 2) | 123 | 456 | 113456789 |

Code

COUNT=0
FOR n=1 TO N−1

| IF L(n)=0 NEXT n | |
|---|---|
| FOR k = 1 to n−1 | |
| | e= SUM(B(n−k) ... B(n−1) |
| I | IF e>L(n) NEXT k |

IF SUBS( CONCATENATE(B(n−k) ... B(n−1)) ,
LEFT (C(n),E))=1 THEN

COUNT = COUNT+1
IF (COUNT > 1) THEN

RETURN FAIL

END IF
nn=n
kk=k

END IF

NEXT k

NEXT n
IF COUNT = 1 THEN

FOR k = (nn−kk) to (nn−1)
DELETE B(k)
RETURN SUCCESS

END IF
RETURN FAIL

1. An automated dialogue apparatus comprising:
a buffer (10) for storing coded representations;
speech generation means (6) operable to generate a speech signal from the coded representation for confirmation by a user;
speech recognition means (2) operable to recognise speech received from the user and generate a coded representation of thereof;
means (5) operable to compare the coded representation from the recogniser of a response from the user with the contents of the buffer to determine, for each of a plurality of different alignments between the coded response and the buffer contents, a respective similarity measure, wherein at least some of said comparisons involve comparing only a leading portion of the coded response with a part of the buffer contents already uttered by the speech generation means; and
means (5) for replacing at least part of the buffer contents with at least part of said recognised response, in accordance with the alignment having the similarity measure indicative of the greatest similarity.

2. An apparatus according to claim 1, including an input buffer operable to hold said coded representation from the recogniser of a response from the user whilst said comparison is performed.

3. An apparatus according to claim 1, arranged so that said coded representation from the recogniser of a response from the user is entered into the buffer prior to said comparison, and the replacing means is operable thereafter to adjust its position in the buffer.

4. An automated dialogue apparatus according to claim 1, further comprising means operable to divide the buffer contents into at least two portions, to supply an earlier portion to the speech generation means and to await a response from the user before supplying a later portion to the speech generation means, wherein at least some of said comparisons involve comparing the coded response with a concatenation of a part of the buffer contents already uttered by the speech generation means and the portion which, in the buffer, immediately follows it.

5. An apparatus according to claim 1 including means operable to record status information defining the buffer contents as confirmed, offered for confirmation but not confirmed, and yet to be offered for confirmation.

6. An apparatus according to claim 5 in which the status information also includes indications of the condition that the respective coded representation has been corrected following non-confirmatory input from the user.

7. An apparatus according to claim 5 in which the status information is recorded by means of pointers indicating boundary positions within the buffer between representations having respective different status.

8. An apparatus according to claim 5 in which the buffer has a plurality of locations each for containing a coded representation, and for each location a status field for storing the associated status.

9. An apparatus according to claim claim 5 in which the similarity measure is a function of (a) differences between the coded representation of the user's response and the contents of the buffer and (b) the status of those contents.

10. An apparatus according to claim 5 in which the similarity measure is a function also of the alignment or otherwise of phrasal boundaries in the representations being compared.

11. An apparatus according to claim 1 in which a portion of the coded representation of the user's response that in any particular alignment precedes the buffer contents is deemed to be different.

12. An apparatus according to claim 1 in which a portion of the coded representation of the user's response that in any particular alignment follows the buffer contents does not contribute to the similarity measure.

13. An apparatus according to claim 1 in which the comparing means is operable in accordance with a dynamic programming algorithm.

14. An apparatus according to claim 1 in which the replacing means is operable, in the event that the alignment having the similarity measure indicative of the greatest similarity is an alignment corresponding to a pure continuation of the part of the buffer contents already uttered by the speech generation means, to enter the coded response into the buffer at such position and to mark the position within the buffer at which such entry began; and further comprising means operable to examine the buffer contents and to compare a part of the buffer contents immediately following a marked position with a part immediately preceding the same marked position to determine whether or not said immediately following part can be interpreted as a correction or partial correction of said immediately preceding part.

15. An apparatus according to claim 14 in which the replacing means is operable, in the event that the alignment having the similarity measure indicative of the greatest similarity is an alignment in which a non-leading portion of the coded response corresponds to a correction of that part of the buffer contents most recently uttered by the speech generation means, to insert the leading portion of the coded response into the buffer before the most recently uttered part, and to mark the position within the buffer at which such insertion began.

16. An apparatus according to claim 14, in which the means to examine and compare is operable in accordance with a dynamic programming algorithm.

17. An automated dialogue apparatus according to claim 1, including means operable to recognise a spoken response containing an indication of non-confirmation and in response thereto to suppress selection of an alignment corresponding to a pure continuation of the part of the buffer contents already uttered by the speech generation means.

18. A method of speech recognition comprising
(a) receiving a coded representation;
(b) performing at least once the steps of
(b1) recognising speech from a speaker to generate a coded representation thereof;
(b2) updating the previous coded representation by concatenation of at least part thereof with this recognised coded representation;
(b3) marking the position within the updated representation at which said concatenation occurred; and
(c) comparing a part of the updated representation immediately following the marked position with a part immediately preceding the same marked position to determine whether or not said immediately following part can be interpreted as a correction or partial correction of said immediately preceding part.

19. A method of speech recognition comprising (a) recognising an utterance from a speaker to generate a coded representation thereof; (b) detecting in the utterance a position that is followed by input having a correcting function and marking this position within the coded representation; and (C) comparing a part of the updated representation immediately following the marked position with a part immediately preceding the same marked position to determine whether or not said immediately following part can be interpreted as a correction or partial correction of said immediately preceding part.

20. A method according to claim 18 including performing the correction or partial correction.

21. A method according to claim 18 including performing the comparison in respect of a plurality of marked positions and performing the correction or partial correction in respect of that one of the marked positions for which a set criterion is satisfied.

22. A method according to claim 18 including performing the comparison in respect of a plurality of marked positions and performing the correction or partial correction in respect of a plurality of marked positions for which a set criterion is satisfied

23. A method according to claim 21 in which the set criterion is that the corrected updated representation corresponds to an expected length.

24. A method according to claim 21 in which the set criterion is that the corrected updated representation matches a predetermined pattern definition.

25. A method according to claim 18 including, in step (b), examining the recognised coded representation to determine whether it is to be immediately interpreted as a correction or partial correction, and performing such correction or partial correction, including continuation, if any;
wherein the steps of concatenation and marking are performed only in the event that the recognised coded representation is determined as not to be immediately interpreted as a correction or partial correction.

26. A method according to claim 18 including generating, for confirmation, a speech signal from only part of the current coded representation, wherein said concatenation occurs at the end of that part.

27. A method according to claim 18 in which the coded representation of step (a) is also generated by recognition of speech from the speaker.

28. A method according to claim 18 in which:
step (b) is performed at least twice;
step (c) comprises performing a plurality of evaluations corresponding to different selections of one or more of said marked positions;
wherein each evaluation comprises performing said comparison in respect of the or each selected marked position and generating a cost measures as a function of the similarity determined by said comparison (s);
and wherein the question of which selection is to be chosen is determined based on said cost measure.

29. A method according to claim 28 in which said plurality of evaluations also include evaluations of the same selection of two or more marked positions processed in a different order.

30. A method according to claim 18 in which said comparison is performed by means of a dynamic programming algorithm.

31. A method of speech recognition comprising
(a) recognising speech received from a speaker and generating a coded representation of each discrete utterance thereof; and storing a plurality of representations of discrete utterances in sequence in a buffer, including markers indicative of divisions between units corresponding to the discrete utterances;
(b) performing a comparison process having a plurality of comparison steps, wherein each comparison step comprises comparing a first comparison sequence (each of which comprises a unit or leading portion thereof) with a second comparison sequence which, in the stored sequence, immediately precedes the first comparison sequence, so as to determine whether the first and second comparison sequences meet a predetermined criterion of similarity;
(c) in the event that the comparison process identifies only one instance of first and second comparison sequences meeting the criterion, deleting the second comparison sequence of that instance from the stored sequence.

32. A method of speech recognition comprising
(a) recognising speech received from a speaker and generating a coded representation of each discrete utterance thereof; and storing a plurality of representations of discrete utterances in sequence in a buffer, including markers indicative of divisions between units corresponding to the discrete utterances;
in response to a parameter which defines an expected length for the stored sequence, the step of comparing the actual length of the stored sequence with the parameter and in the event that the actual length exceeds the parameter:
(b) performing a comparison process having a plurality of comparison steps, wherein each comparison step comprises comparing a first comparison sequence (each of which comprises a unit or leading portion thereof) with a second comparison sequence which, in the stored sequence, immediately precedes the first comparison sequence, so as to determine whether the first and second comparison sequences meet a predetermined criterion of similarity;
(c) in the event that the comparison process identifies only one instance where both (i) the length of the second comparison sequence is equal to the difference between the actual and expected length and (ii) the first and second comparison sequences meet the criterion, deleting the second comparison sequence of that instance from the stored sequence.

33. A method according to claim 31 comprising, in the case that no deletion is performed at step (c), performing a further such comparison process having a different predetermined criterion and/or a different manner of selection of the first and second comparison sequences.

34. A method of speech recognition comprising
(a) storing a coded representation;
(b) selecting a portion of the stored coded representation;
(c) supplying the selected portion to speech generation means operable to generate a speech signal therefrom for confirmation by a user;
(d) recognising a spoken response from the user to generate a coded representation thereof; and
(e) updating the stored coded representation on the basis of the recognised response; wherein said updating includes updating at least one part of the stored coded representation other than the selected portion.

35. A method according to claim 34 including the step of (F) repeating steps (b) to (d) at least once.

36. A method according to claim 34 including generating for each selected portion a first marker indicative of the position thereof within the stored coded representation.

37. A method according to claim 34 in which said updating includes, according to the content of the recognised coded representation, one or more of:
(i) correcting the selected portion or part thereof;
(ii) entering at least part of the recognised coded representation into the stored coded representation at a position immediately following the selected portion.

38. A method according to claim 37 in which said updating includes, according to the content of the recognised coded representation,
(iii) inserting a leading part of the recognised coded representation into the stored coded representation at a position before the selected portion.

39. A method according to claim 37 including generating for each entered part and any inserted part a second marker indicative of the position thereof within the stored coded representation.

40. A method according to claim 39 comprising the subsequent step of comparing, for the or each second marker, a part of the updated representation immediately following a position marked by that second marker with a part immediately preceding the same marked position to determine whether said immediately following part can be interpreted as a correction or partial correction of said immediately preceding part.

41. A method according to claim 25 comprising the subsequent step of comparing, for the or each second marker, a part of the updated representation immediately following a position marked by that second marker with a part immediately preceding the same marked position to determine whether said immediately following part can be interpreted as a correction or partial correction of said immediately preceding part in which said subsequent step of comparing compares a part of the updated representation immediately following a position marked by a second marker preferentially or exclusively with one or more immediately preceding parts marked by a first marker.

42. An automated dialogue apparatus comprising
speech generation means operable to generate a speech signal from a coded representation for confirmation by a user, characterised by means operable in dependence on the length of the coded representation to divide the coded representation into at least two portions, to supply a first portion to the speech generation means and to await a response from the user before supplying any further portion to the speech generation means.

43. An apparatus according to claim 42 including means for recognising predetermined patterns in the coded representation and wherein upon such recognition one of the portions is determined by reference to a recognised pattern.

44. An automated dialogue apparatus comprising:
speech generation means operable to generate a speech signal from a coded representation for confirmation by a user; and
means operable to divide the coded representation into at least two portions, to supply a first portion to the speech generation means and to await a response from the user before supplying any further portion to the speech generation means;
characterised by means for recognising predetermined patterns in the coded representation and wherein upon such recognition one of the portions is determined by reference to a recognised pattern.

45. An apparatus according to claim 43 in which the predetermined patterns are predetermined digit sequences occurring at the commencement of the representation.

46. An apparatus according to claim 45 for recognising telephone numbers, in which the coded representation is a representation of numeric digits.

47. An apparatus according to claim 45 in which the remainder of the coded representation is divided into portions such that each such portion shall not exceed a predetermined length.

48. An apparatus according to claim 42 including speech recognition means operable to recognise speech received from the user and generate the coded representation therefrom.

49. An automated dialogue apparatus comprising:
a buffer (10) for storing coded representations;
speech recognition means (2) operable to recognise speech received from the user, including detecting phrasal boundaries in said input speech, and to store in the buffer a coded representation of the recognised speech and markers indicative of the positions of said phrasal boundaries;
speech generation means (6) operable to generate a speech signal from the coded representation for confirmation by a user;
control means operable in response to the phrase boundary markers to divide the coded representation into at least two portions, to supply a first portion to the speech generation means for a response from the user before supplying any further portion to the speech generation means.

50. An automated dialogue method comprising:
storing coded representations including markers indicative of points of ambiguity; comparing, for each of a plurality of different alignments thereof, a part of the coded representations immediately following a marked point with a part immediately preceding the same marked point to determine whether or not said immediately following part can be interpreted as a correction or partial correction of said immediately preceding part; wherein at least some of said comparisons involve comparing only a leading portion of said immediately following part with said immediately preceding part.

51. An automated dialogue apparatus comprising:
speech recognition means operable to recognise speech received from a speaker and generate a coded representation thereof;
timeout means operable to determine in accordance with a silence duration parameter when an utterance being recognised is deemed to have ended;
characterised by means operable, during an utterance, in dependence on the contents of the utterance to date, to vary the timeout parameter for the continuation of that utterance.

52. An automated dialogue apparatus according to claim 51 in which said variation is conditional upon the initial part of the utterance matching a predetermined pattern.

53. An automated dialogue apparatus according to claim 51 in which said variation is conditional upon recognition in the utterance of input indicative of negative confirmation to increase the timeout parameter for the remainder of that utterance.

54. An automated dialogue apparatus comprising:
speech recognition means operable to recognise speech received from a speaker and generate a coded representation thereof;
timeout means operable to determine in accordance with a silence duration parameter when an utterance being recognised is deemed to have ended;
characterised by means operable in dependence on a dialogue state to vary the timeout parameter.
